(19) United States
(12) Patent Application Publication
(10) Pub. No.: US 2026/0072389 A1
(43) Pub. Date: Mar. 12, 2026

(54) SHEET CONVEYANCE APPARATUS AND IMAGE FORMING APPARATUS

(71) Applicant: CANON KABUSHIKI KAISHA, Tokyo (JP)

(72) Inventor: WATARU TAKAHASHI, Chiba (JP)

(21) Appl. No.: 19/307,214

(22) Filed: Aug. 22, 2025

(30) Foreign Application Priority Data
Sep. 11, 2024 (JP) 2024-157502

(51) Int. Cl. G03G 15/00; G03G 15/01

(52) U.S. Cl. CPC G03G 15/6564; G03G 15/6567; G03G 15/0189; G03G 2215/00405; G03G 2215/00679; G03G 2215/00721; G03G 2215/00945

(57) ABSTRACT

A sheet conveyance apparatus includes a conveyance rotary member pair, an abutment portion, a first skewing rotary member pair, a switching unit, a driving unit, and a control unit. The switching unit switches the first skewing rotary member pair between a nipping conveyance state in which a sheet is nipped and conveyed and a non-nipping state in which nipping of the sheet is released. The control unit controls a rotational speed of the first skewing rotary member pair to be a first speed when the sheet is obliquely conveyed to the abutment portion by the first skewing rotary member pair, and controls the rotational speed of the first skewing rotary member pair to be a second speed lower than the first speed when the first skewing rotary member pair is in the non-nipping state and the conveyance rotary member pair conveys the sheet.

### BACKGROUND

### Field of the Technology

The present disclosure relates to a sheet conveyance apparatus that conveys a sheet, and an image forming apparatus.

### Description of the Related Art

For example, as an image forming apparatus such as a printer, there has been proposed an image forming apparatus adopting a so-called side registration method in which a sheet is obliquely conveyed by a skewing roller pair and an edge portion of the sheet abuts against an abutment member (see JP 2021-134050 A and JP 2019-23135 A). In JP 2021-134050 A, the sheet conveyed by a conveyance roller pair abuts against a reference surface of a reference member by a plurality of skewing rollers and is conveyed to a registration roller. Thereafter, once the sheet is nipped by the registration roller, nipping by the skewing rollers is released, and the registration roller is slid by a certain amount in a width direction, thereby conveying the sheet in a state in which a position of the sheet is aligned with a position of an image on an intermediate transfer belt.

In addition, when the sheet conveyed by the conveyance roller pair is far from the reference member in the width direction, the sheet may strongly abut against the reference member and be buckled in a case where an angle of the skewing roller is increased to cause the sheet to arrive at the reference member. For this reason, as disclosed in JP 2019-23135 A, there has been proposed a method in which an angle of the skewing roller positioned on a far side from the reference member in the width direction is made larger than an angle of the skewing roller positioned on a near side. In JP 2019-23135 A, pressurization of the skewing roller positioned on the near side is released, and the skewing roller positioned on the far side is pressurized, so that the sheet is brought close to the reference member by the skewing roller on the far side. Then, the skewing roller on the near side is pressurized, and the pressurization of the skewing roller on the far side is released. Accordingly, after the sheet is brought close to the reference member by the skewing roller on the far side, the sheet is brought into contact with the reference member by the skewing roller on the near side, whereby the sheet is prevented from strongly abutting against the reference member.

In JP 2021-134050 A, a rotation angle direction of the skewing roller is different from a rotation angle direction of the registration roller, and in JP 2019-23135 A, a rotation angle direction of the skewing roller on the far side is different from a rotation angle direction of the skewing roller on the near side. In such a configuration, a relative speed difference in a sheet conveyance direction of the apparatus occurs in a state in which pressurization of one roller is released and the sheet is conveyed by the other roller. Therefore, there is room for improvement due to the occurrence of the relative speed difference in the sheet conveyance direction.

### SUMMARY

Therefore, the present disclosure provides a new technology related to a configuration for reducing occurrence of a relative rotational speed difference between skewing rollers.

According to a first aspect of the present disclosure, a sheet conveyance apparatus includes a conveyance rotary member pair configured to nip and convey a sheet, an abutment portion disposed on one side in a width direction orthogonal to a sheet conveyance direction with respect to the sheet being conveyed, a first skewing rotary member pair disposed downstream of the conveyance rotary member pair in the sheet conveyance direction and configured to obliquely convey the sheet toward the abutment portion, a switching unit configured to switch the first skewing rotary member pair between a nipping conveyance state in which the sheet is nipped and conveyed and a non-nipping state in which nipping of the sheet is released, a driving unit configured to rotationally drive the first skewing rotary member pair, and a control unit configured to control the switching unit and the driving unit. The control unit is configured to control a rotational speed of the first skewing rotary member pair to be a first speed in a case where the sheet is obliquely conveyed to the abutment portion by the first skewing rotary member pair, and control the rotational speed of the first skewing rotary member pair to be a second speed lower than the first speed in a case where the first skewing rotary member pair is in the non-nipping state and the conveyance rotary member pair conveys the sheet.

According to a second aspect of the present disclosure, a sheet conveyance apparatus includes an abutment portion disposed on one side in a width direction orthogonal to a sheet conveyance direction with respect to a sheet being conveyed, a first skewing rotary member pair configured to obliquely convey the sheet toward the abutment portion, a second skewing rotary member pair configured to obliquely convey the sheet toward the abutment portion, a first switching mechanism configured to switch the first skewing rotary member pair between a nipping conveyance state in which the sheet is nipped and conveyed and a non-nipping state in which nipping of the sheet is released, a fourth switching mechanism configured to switch the second skewing rotary member pair between a nipping conveyance state in which the sheet is nipped and conveyed and a non-nipping state in which nipping of the sheet is released, a first driving unit configured to rotationally drive the first skewing rotary member pair, a fourth driving unit configured to rotationally drive the second skewing rotary member pair, and a control unit configured to control the first switching mechanism, the fourth switching mechanism, the first driving unit, and the fourth driving unit. The second skewing rotary member pair is disposed such that the first skewing rotary member pair is positioned between the second skewing rotary member pair and the abutment portion in the width direction. The second skewing rotary member pair is disposed such that an angle between an oblique conveyance direction of the second skewing rotary member pair and the sheet conveyance direction is larger than an angle between an oblique conveyance direction of the first skewing rotary member pair and the sheet conveyance direction. The control unit is configured to control a rotational speed of the first skewing rotary member pair to be a first speed in a case where the second skewing rotary member pair is in the non-nipping state and the sheet is obliquely conveyed to the abutment portion by the first skewing rotary member pair, and control the rotational speed of the first skewing rotary member pair to be a fourth speed higher than the first speed in a case where the first skewing rotary member pair is in the non-nipping state and the sheet is obliquely conveyed to the first skewing rotary member pair by the second skewing rotary member pair.

According to a third aspect of the present disclosure, a sheet conveyance apparatus includes an abutment portion disposed on one side in a width direction orthogonal to a sheet conveyance direction with respect to a sheet being conveyed, a first skewing rotary member pair configured to obliquely convey the sheet toward the abutment portion, a second skewing rotary member pair configured to obliquely convey the sheet toward the abutment portion, a first switching mechanism configured to switch the first skewing rotary member pair between a nipping conveyance state in which the sheet is nipped and conveyed and a non-nipping state in which nipping of the sheet is released, a fourth switching mechanism configured to switch the second skewing rotary member pair between a nipping conveyance state in which the sheet is nipped and conveyed and a non-nipping state in which nipping of the sheet is released, a first driving unit configured to rotationally drive the first skewing rotary member pair, a fourth driving unit configured to rotationally drive the second skewing rotary member pair, and a control unit configured to control the first switching mechanism, the fourth switching mechanism, the first driving unit, and the fourth driving unit. The second skewing rotary member pair is disposed such that the first skewing rotary member pair is positioned between the second skewing rotary member pair and the abutment portion in the width direction. The second skewing rotary member pair is disposed such that an angle between an oblique conveyance direction of the second skewing rotary member pair and the sheet conveyance direction is larger than an angle between an oblique conveyance direction of the first skewing rotary member pair and the sheet conveyance direction. The control unit is configured to control a rotational speed of the second skewing rotary member pair to be a fifth speed in a case where the first skewing rotary member pair is in the non-nipping state and the sheet is obliquely conveyed to the first skewing rotary member pair by the second skewing rotary member pair, and control the rotational speed of the second skewing rotary member pair to be a sixth speed lower than the fifth speed in a case where the second skewing rotary member pair is in the non-nipping state and the sheet is obliquely conveyed to the abutment portion by the first skewing rotary member pair.

According to a fourth aspect of the present disclosure, an image forming apparatus includes the sheet conveyance apparatus, and an image forming unit disposed downstream of the sheet conveyance apparatus in the sheet conveyance direction and configured to form an image on the sheet.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic view illustrating a printer according to a first embodiment.

FIG. 2 is a top view illustrating a registration unit according to the first embodiment.

FIG. 3A is a cross-sectional view illustrating a part of a conveyance section in a nipping conveyance state in the registration unit.

FIG. 3B is a cross-sectional view illustrating a part of the conveyance section in a non-nipping state in the registration unit.

FIG. 4 is a perspective view illustrating a part of the conveyance section in the registration unit.

FIG. 5A is a top view illustrating a part of a skew feeding correction section in the registration unit.

FIG. 5B is a cross-sectional view illustrating a part of the skew feeding correction section in the registration unit when viewed from a sheet conveyance direction.

FIG. 6A is a perspective view illustrating a skewing roller pair and a pressurization mechanism thereof.

FIG. 6B is a side view illustrating the skewing roller pair and a part of the pressurization mechanism thereof.

FIG. 7A is a side view illustrating the skewing roller pair in a nipping conveyance state.

FIG. 7B is a side view illustrating the skewing roller pair in a non-nipping state.

FIG. 8 is a perspective view illustrating a sheet position detection sensor in the conveyance section of the registration unit.

FIG. 9 is a perspective view illustrating a driving mechanism of a conveyance roller pair in the conveyance section of the registration unit.

FIG. 10 is a perspective view illustrating a sliding mechanism of the conveyance roller pair in the conveyance section of the registration unit.

FIG. 11A is a perspective view illustrating a pressurization releasing mechanism of the conveyance roller pair in the conveyance section of the registration unit.

FIG. 11B is a cross-sectional view illustrating the pressurization releasing mechanism of the conveyance roller pair in the conveyance section of the registration unit.

FIG. 12 is a block diagram illustrating a control system of a printer according to the first embodiment.

FIG. 13A is a top view illustrating a state in which a sheet is conveyed to the conveyance section of the registration unit according to the first embodiment.

FIG. 13B is a cross-sectional view illustrating the state illustrated in FIG. 13A.

FIG. 13C is a top view illustrating a state in which the sheet is shifted in a width direction by the conveyance roller pair 34-3 in the state illustrated in FIGS. 13A and 13B.

FIG. 13D is a cross-sectional view illustrating the state illustrated in FIG. 13C.

FIG. 14A is a top view illustrating a state in which skew feeding correction is performed in the skew feeding correction section of the registration unit according to the first embodiment.

FIG. 14B is a cross-sectional view illustrating the state illustrated in FIG. 14A.

FIG. 15A is a top view illustrating a state in which shifting is performed by a registration roller pair of the registration unit according to the first embodiment.

FIG. 15B is a cross-sectional view illustrating the state illustrated in FIG. 15A.

FIG. 16 is a flowchart illustrating control of the conveyance section of the registration unit during execution of a normal print job according to the first embodiment.

FIG. 17 is a flowchart illustrating control of the skew feeding correction section and the registration roller pair of the registration unit during execution of the normal print job according to the first embodiment.

FIG. 18 is a diagram illustrating a relationship between a conveyance direction speed and an abutment direction speed for the skewing roller pair and the registration roller pair.

FIG. 19A is a diagram illustrating a relationship between the conveyance direction speed and the abutment direction speed for the skewing roller pair, the registration roller pair, and the sheet in a state in which the sheet is obliquely conveyed by the skewing roller pairs.

FIG. 19B is a diagram illustrating a relationship between the conveyance direction speed and the abutment direction speed for the skewing roller pair, the registration roller pair, and the sheet in a state in which the sheet is conveyed by the registration roller pair.

FIG. 20 is a top view illustrating a registration unit according to a second embodiment.

FIG. 21 is a top view illustrating a state in which a sheet is skew-fed by a skewing roller pair 32-4 in a skew feeding correction section of the registration unit according to the second embodiment.

FIG. 22 is a flowchart illustrating control of the skew feeding correction section and a registration roller pair of the registration unit during execution of a normal print job according to the second embodiment.

FIG. 23A is a diagram illustrating a relationship between a conveyance direction speed and an abutment direction speed for the skewing roller pair 32-4, a skewing roller pair 32-1, and the sheet in a state in which the sheet is obliquely conveyed by the skewing roller pair 32-4 in the second embodiment.

FIG. 23B is a diagram illustrating a relationship between the conveyance direction speed and the abutment direction speed for the skewing roller pair 32-4, the skewing roller pair 32-1, and the sheet in a state in which the sheet is obliquely conveyed by the skewing roller pair 32-1 in the second embodiment.

### DESCRIPTION OF THE EMBODIMENTS

### First Embodiment

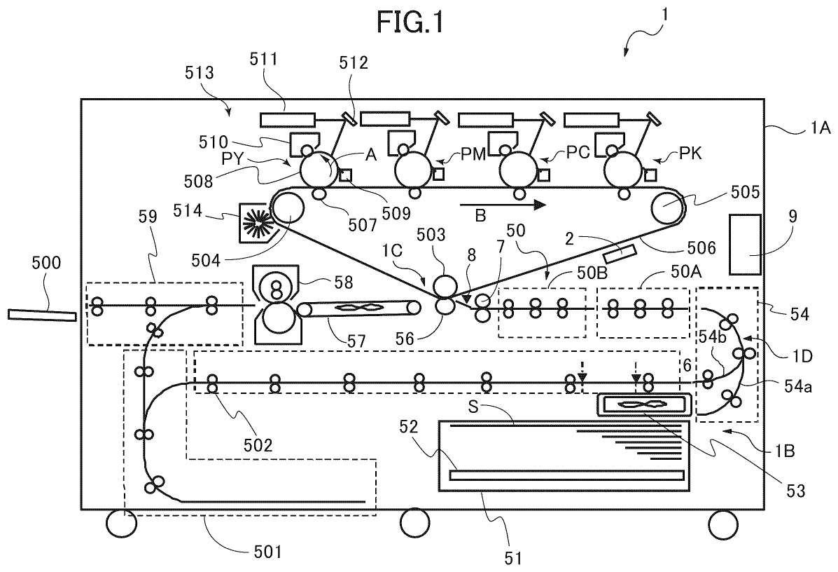

Hereinafter, a first embodiment will be described with reference to FIGS. 1 to 19B. First, a schematic configuration of a printer 1 serving as an image forming apparatus including a registration unit 50 serving as a sheet conveyance apparatus according to the first embodiment will be described. FIG. 1 is a schematic diagram illustrating the printer according to the first embodiment. In the printer 1, various sheets such as paper such as a paper sheet and an envelope, glossy paper, a plastic film such as a sheet for an overhead projector, and cloth can be used as a sheet used as a recording medium.

### Configuration of Printer

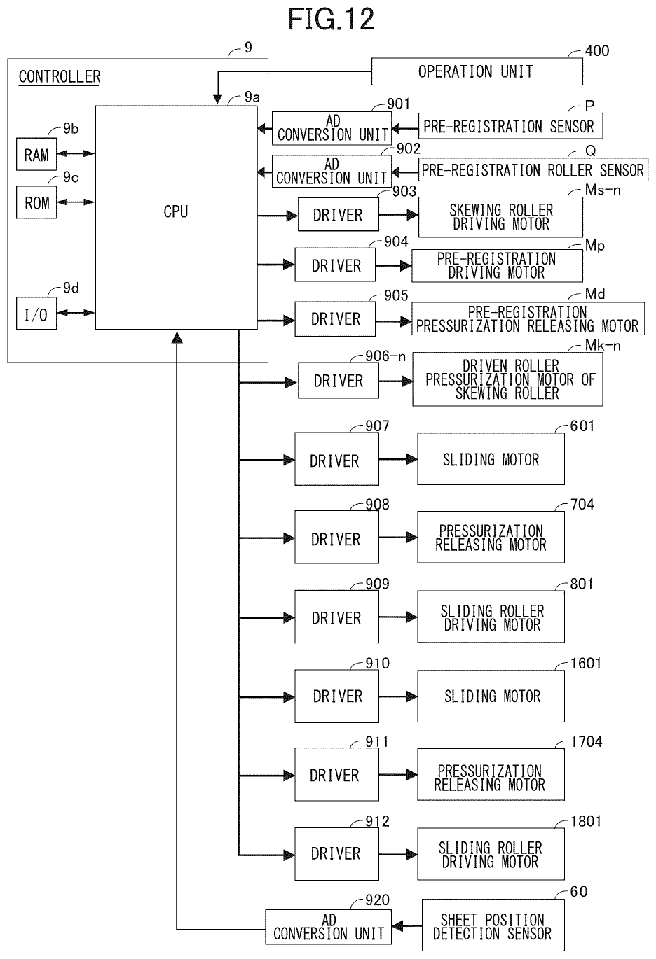

As illustrated in FIG. 1, the printer 1 includes a control unit 9 (see FIG. 12) that controls an overall operation of the printer 1 based on image information input from an external personal computer (PC) or image information read from a document. An apparatus body 1A of the printer 1 accommodates a sheet cassette 51 that stores a sheet S, and an image forming engine 513 serving as an image forming unit that forms an image on the sheet S fed from the sheet cassette 51. The image forming engine 513, which is an example of the image forming unit, includes four image forming process units PY, PM, PC, and PK that form toner images of yellow, magenta, cyan, and black, respectively, and an intermediate transfer belt 506 serving as an image bearing member. The image forming engine 513 forms the image on the sheet S by a tandem type intermediate transfer method. Each of the image forming process units PY to PK is an electrophotographic unit including a photosensitive drum 508 which is a photosensitive member.

The image forming process units PY to PK have a common configuration except that colors of toners used for development are different. Here, a configuration of the image forming engine 513 and an image forming process for the toner image will be described using the yellow image forming process unit PY as an example. The image forming process unit PY includes an exposure device 511, a developing device 510, and a drum cleaner 509 in addition to the photosensitive drum 508. The photosensitive drum 508 is a drum-shaped photosensitive member including a photosensitive layer provided at an outer peripheral portion, and rotates in a direction (an arrow A in FIG. 1) along a rotation direction (an arrow B in FIG. 1) of the intermediate transfer belt 506. A surface of the photosensitive drum 508 is charged by receiving a charge supplied from a charging unit such as a charging roller (not illustrated). The exposure device 511 irradiates the photosensitive drum 508 with laser light modulated according to the image information and scans the photosensitive drum with an optical system including a reflection device 512 to draw an electrostatic latent image on the surface of the photosensitive drum 508. The developing device 510 accommodates a developer containing the toner and supplies the toner to the photosensitive drum 508 to visualize the electrostatic latent image as the toner image. The toner image formed on the photosensitive drum 508 is primarily transferred to the intermediate transfer belt 506 at a primary transfer portion which is a nip portion between a primary transfer roller 507 and the intermediate transfer belt 506. The residual toner remaining on the photosensitive drum 508 after the transfer is removed by the drum cleaner 509.

The intermediate transfer belt 506 is wound around a driving roller 504, a driven roller 505, a secondary transfer inner roller 503, and the primary transfer roller 507, and is rotationally driven in a clockwise direction (arrow B) in FIG. 1 by the driving roller 504. The image forming process described above is performed in parallel in each of the image forming process units PY to PK, and the toner images of four colors are sequentially transferred so as to be superimposed on each other, so that a full-color toner image is formed on the intermediate transfer belt 506. The toner image is conveyed to a secondary transfer portion 1C while being borne on the intermediate transfer belt 506. The secondary transfer portion 1C is configured as a nip portion between a secondary transfer roller 56 serving as a transfer roller and the secondary transfer inner roller 503. A bias voltage having a polarity opposite to a charging polarity of the toner is applied to the secondary transfer roller 56, whereby the toner image is secondarily transferred to the sheet S. The residual toner remaining on the intermediate transfer belt 506 after the transfer is removed by a belt cleaner 514.

The sheet S to which the toner image has been transferred is delivered to a fixing unit 58 by a pre-fixing conveyance section 57. The fixing unit 58 includes a fixing roller pair that nips and conveys the sheet S and a heat source such as a halogen heater, and applies a pressure and heat to the toner image borne on the sheet S. As a result, toner particles are melted and fixed, and the toner image is fixed to the sheet S.

Next, a sheet conveyance process of conveying the sheet will be described. A sheet conveyance system 1D of the printer 1 conveys the sheet S fed from a sheet feeding section 1B serving as a sheet feeding device and discharges the sheet S on which the image is formed to the outside of the apparatus body 1A. The sheet conveyance system 1D includes a sheet conveyance section 54, the registration unit 50, the pre-fixing conveyance section 57, a branch conveyance section 59, a reverse conveyance section 501, and a duplex-printing conveyance section 502 serving as a re-conveyance unit.

The sheet cassette 51 provided in a sheet feeding section 1B is mounted on the apparatus body 1A so as to be able to be pulled out, and the sheets S are stored in a state of being stacked and supported on a lifting tray 52 that can be lifted and lowered and are fed one by one by a sheet feeding section 53. Examples of the sheet feeding section 53 include a belt type in which the sheet S is sucked to a belt member by a suction fan and conveyed, and a friction separation type using a roller or a pad. The sheet S fed from the sheet feeding section 53 is conveyed along a feeding path 54a by a conveyance roller pair of the sheet conveyance section 54 and is delivered to the registration unit 50.

The sheet S delivered to the registration unit 50 is conveyed toward the secondary transfer portion 1C after skew feeding correction or timing correction is performed. At this time, a registration roller pair 7 of the registration unit 50 sends the sheet S to the secondary transfer portion 1C according to the progress of the image forming processes by the image forming process units PY to PK based on detection of the sheet by a sheet detection sensor 8. The sheet S to which the toner image has been transferred at the secondary transfer portion 1C and to which the image has been fixed by the fixing unit 58 is conveyed to the branch conveyance section 59 where a conveyance path of the sheet S branches. When the image formation on the sheet S is completed, the sheet S is discharged to a discharge tray 500 disposed outside the apparatus body 1A by a discharge roller pair.

On the other hand, in the case of forming an image on a back surface of the sheet S, the sheet S is delivered to the duplex-printing conveyance section 502 via the reverse conveyance section 501. The reverse conveyance section 501 includes a reversing roller pair capable of forward rotation and reverse rotation and flips the sheet by a switchback method of reversing front and back sides of the sheet S. That is, the reverse conveyance section 501 reverses a conveyance direction after retracting a leading edge of the sheet to flip the sheet, and delivers the sheet to the duplex-printing conveyance section 502. The duplex-printing conveyance section 502 conveys the sheet S again toward the registration unit 50 via a feeding path 54b of the sheet conveyance section 54. Then, the sheet S is discharged to the discharge tray 500 after the image is formed on the back surface.

### Configuration of Registration Unit

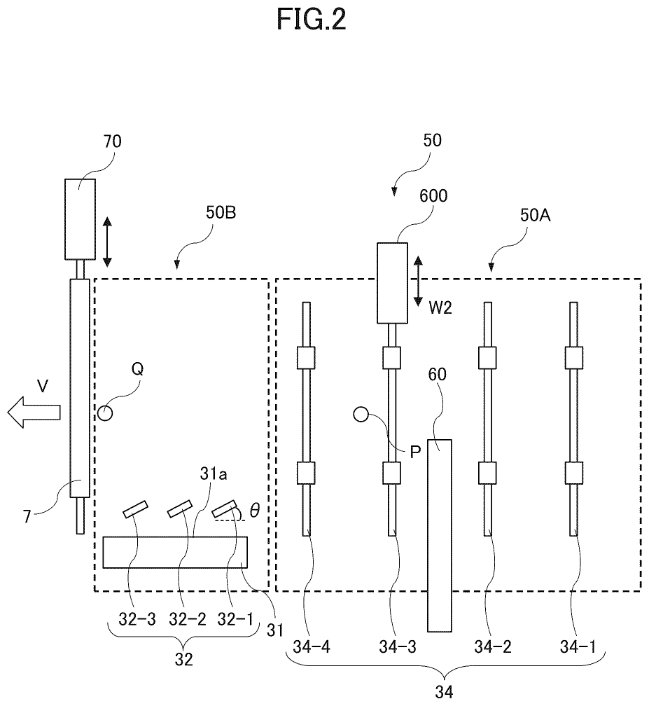

Next, a configuration of the registration unit 50 included in the sheet conveyance apparatus will be described with reference to FIG. 2. FIG. 2 is a top view illustrating the registration unit. The registration unit 50 according to the present embodiment is a unit that corrects skew feeding of the sheet by a side registration method.

Specifically, as illustrated in FIG. 2, the registration unit 50 includes a conveyance section 50A, a skew feeding correction section 50B, and the registration roller pair 7 in order from upstream to downstream in a sheet conveyance direction. Further, the registration unit 50 includes a sheet position detection sensor 60 serving as a width position detection unit that detects a position of an edge portion of the sheet in a width direction orthogonal to the sheet conveyance direction. The registration unit 50 further includes a sliding mechanism 600 that moves one roller of a conveyance roller pair of the conveyance section 50A in the width direction orthogonal to the sheet conveyance direction. The conveyance section 50A includes at least one conveyance roller pair that conveys the sheet in the sheet conveyance direction, and FIG. 2 illustrates a configuration in which conveyance roller pairs 34-1, 34-2, 34-3, and 34-4 are provided. In the following description, when it is not necessary to distinguish the conveyance roller pairs 34-1, 34-2, 34-3, and 34-4, the conveyance roller pairs 34-1, 34-2, 34-3, and 34-4 are referred to as a “conveyance roller pair 34”.

In the registration unit 50 in the present embodiment, the sliding mechanism 600 serving as a second movement driving unit is provided on the conveyance roller pair 34-3 serving as a conveyance rotary member pair. FIG. 2 illustrates a configuration in which the sheet position detection sensor 60 is disposed at a position between the conveyance roller pair 34-2 and the conveyance roller pair 34-3. In addition to the configuration illustrated in FIG. 2, the sheet position detection sensor 60 can be disposed at a position where the edge portion of the sheet being conveyed in the conveyance section 50A in the width direction can be detected, for example, at a position between the conveyance roller pair 34-1 and the conveyance roller pair 34-2.

The skew feeding correction section 50B includes skewing roller pairs 32-1, 32-2, and 32-3 serving as first skewing rotary member pairs, and a reference member 31 serving as an abutment portion. The skewing roller pairs 32-1, 32-2, and 32-3 are arranged on a straight line substantially aligned with a sheet conveyance direction V. In other words, the skewing roller pairs 32-1, 32-2, and 32-3 are arranged so as to at least partially overlap each other when viewed in the sheet conveyance direction V. In the following description, when it is not necessary to distinguish the skewing roller pairs 32-1, 32-2, and 32-3, the skewing roller pairs 32-1, 32-2, and 32-3 are referred to as a “skewing roller pair 32”. The reference member 31 has a reference surface 31a extending in the sheet conveyance direction, and is disposed on one side in the width direction orthogonal to the sheet conveyance direction. The reference surface 31a extends in the sheet conveyance direction and is an abutment surface that can abut against one edge portion of the sheet in the width direction.

A pre-registration sensor (hereinafter, referred to as a “pre-registration sensor”) P that detects arrival of the leading edge of the sheet by detecting the presence or absence of the sheet is disposed in the vicinity of the conveyance roller pair 34-3. As the pre-registration sensor P, for example, a reflective photoelectric sensor including a light emitting unit and a light receiving unit can be used. In this case, light emitted from the light emitting unit is reflected by the sheet arriving at a detection position, and the light receiving unit detects reflected light to detect a passage timing of the sheet. As illustrated in FIG. 2, in the present embodiment, the pre-registration sensor P is disposed between the conveyance roller pair 34-3 and the conveyance roller pair 34-4 in the sheet conveyance direction.

Each of the skewing roller pairs 32-1, 32-2, and 32-3 rotates about an axis inclined with respect to the width direction. That is, the skewing roller pairs 32-1, 32-2, and 32-3 are arranged in parallel to each other such that a tangential direction at a contact portion for the sheet is a direction inclined at an angle θ with respect to the sheet conveyance direction V. Therefore, the skewing roller pairs 32-1, 32-2, and 32-3 rotate while abutting on the sheet to move the sheet closer to the reference surface 31a of the reference member 31 in the width direction toward a downstream side in the sheet conveyance direction V. Further, the sheet moves so as to approach the reference surface 31a toward the downstream side in the sheet conveyance direction V by the skewing roller pairs 32.

Here, skew feeding correction for the sheet by the skew feeding correction section 50B will be described. The skew feeding correction section 50B corrects skew feeding of the sheet by the so-called side registration method. Specifically, the skew feeding correction section 50B causes a side end of the sheet, that is, the edge portion of the sheet in the width direction, to abut against the reference member 31 having the reference surface 31a extending in the sheet conveyance direction V. After the sheet abuts against the reference surface 31a, the side end of the sheet is moved along the reference surface 31a, thereby correcting the skew feeding of the sheet. The sheet conveyance direction V is a direction in which the sheet travels by the conveyance roller pair 34 of the conveyance section 50A, or a traveling direction in which the sheet is conveyed toward the secondary transfer portion 1C by the registration roller pair 7.

In addition to the pre-registration sensor P, the skew feeding correction section 50B includes a pre-registration sensor Q serving as an arrival detection unit that detects arrival of the leading edge of the sheet by detecting the presence or absence of the sheet. The pre-registration sensor Q is disposed downstream of the skewing roller pairs 32 and upstream of the registration roller pair 7 in the sheet conveyance direction. Similarly to the pre-registration sensor P, a known sensor such as a reflective photoelectric sensor can be used as the pre-registration sensor Q. The pre-registration sensor Q is a sensor for detecting the arrival of the sheet at the registration roller pair 7. Specifically, the arrival of the sheet at the registration roller pair 7 is detected when a predetermined delay time elapses after the pre-registration sensor Q detects the sheet. That is, it can be said that the pre-registration sensor Q functions to detect the arrival of the sheet at the registration roller pair 7. The pre-registration sensor Q may be disposed downstream of the registration roller pair 7. In this case, it is detected that the sheet has already arrived at the registration roller pair 7.

The registration roller pair 7 serving as a downstream conveyance rotary member pair is slidably movable in the width direction orthogonal to the sheet conveyance direction in a state of nipping the sheet by a sliding mechanism 70 serving as a first movement driving unit. As the sliding mechanism 70, a mechanism similar to the sliding mechanism 600 that moves the conveyance roller pair 34-3 in the width direction can be used. In addition, the registration roller pair 7 moves the sheet whose side end abuts against the reference surface 31a of the reference member 31 in the width direction according to a position of the image to be transferred at the secondary transfer portion 1C. As a result, the sheet moves such that the center of the sheet subjected to skew feeding correction in the registration unit 50 in the width direction is aligned with the center of the image to be transferred at the secondary transfer portion 1C (the center of an image forming region in the width direction) in the width direction. Further, a method of adjusting the positions of the sheet and the image to be formed on the sheet is not limited thereto. For example, the adjustment may be performed in a manner in which the registration roller pair 7 moves the sheet such that the center of the sheet is aligned with a conveyance center of the printer 1, and the center of the position of the toner image formed by the image forming process units PY to PK in a main scanning direction is aligned with the center in the width direction.

### Detailed Configuration of Conveyance Section

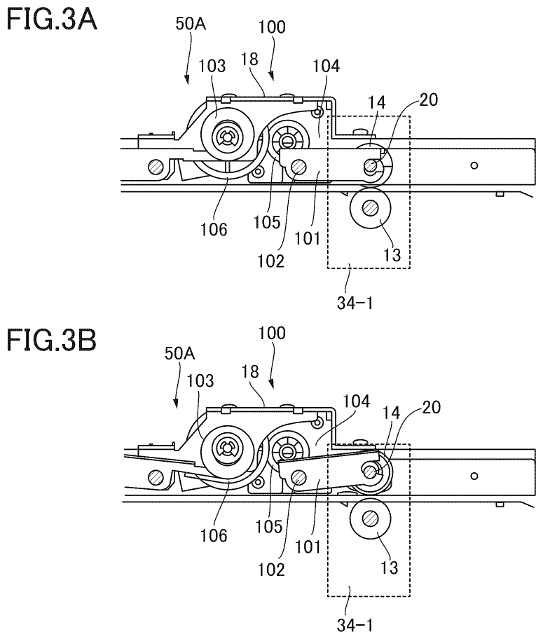

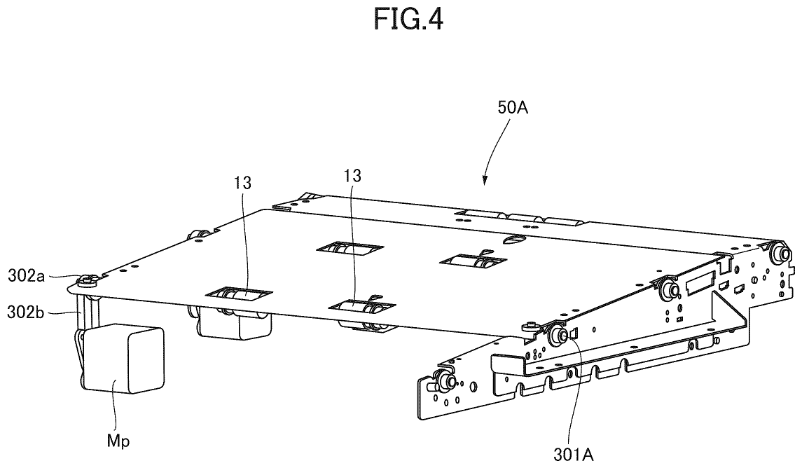

A detailed configuration of the conveyance section 50A will be described in detail with reference to FIGS. 3A, 3B, and 4. FIG. 3A is a cross-sectional view illustrating a part of the conveyance section in a nipping conveyance state in the registration unit. FIG. 3B is a cross-sectional view illustrating a part of the conveyance section in a non-nipping state in the registration unit. FIG. 4 is a perspective view illustrating a part of the conveyance section in the registration unit. FIGS. 3A and 3B illustrate a portion of the conveyance roller pair 34-1 which is one of the four conveyance roller pairs 34. Since the conveyance roller pairs 34-2, 34-3, and 34-4 have the same configuration as the conveyance roller pair 34-1, in the following description, the portion of the conveyance roller pair 34-1 will be described, and a description of portions of the conveyance roller pairs 34-2, 34-3, and 34-4 will be omitted. In the present embodiment, the printer 1 includes four conveyance roller pairs 34 (see FIG. 2) as an example, but the number of conveyance roller pairs is not limited thereto.

As illustrated in FIGS. 3A and 3B, in the conveyance section 50A, the conveyance roller pair 34-1 includes a driving roller 13 to which a driving force is input and a driven roller 14 that rotates following the driving roller 13. The conveyance roller pair 34-1 can be switched between the nipping conveyance state (FIG. 3A) in which the sheet can be nipped and conveyed at a nip portion and the non-nipping state (FIG. 3B) in which the nip portion is separated and the sheet is thus not nipped. Whether or not all the conveyance roller pairs 34 can be switched between the nipping conveyance state and the non-nipping state can be determined according to a size of the sheet that can be conveyed by the printer 1.

The conveyance section 50A is provided with a cam mechanism 100 including an eccentric roller 103 as a switching unit capable of switching between the nipping conveyance state and the non-nipping state of the conveyance roller pair 34-1. The eccentric roller 103 is rotationally driven by a pre-registration pressurization releasing motor Md (see FIG. 12) via gears 105 and 106 and swings an arm member 101 abutting on a cam surface of an outer peripheral portion. The arm member 101 is swingably supported with respect to a stay member 18 about a swing shaft 102, abuts on the eccentric roller 103 on one side of the swing shaft 102, and supports a driven shaft 20 which is a rotation shaft of the driven roller 14 on the other side. Due to the swinging of the arm member 101, each driven roller 14 moves onto and out of a sheet conveyance path formed by a guide member (not illustrated). Therefore, a positional relationship between the driven roller 14 and the driving roller 13 can be switched by controlling a rotation angle of the eccentric roller 103 via the pre-registration pressurization releasing motor Md that is a stepping motor. That is, by controlling the rotation angle of the eccentric roller 103, it is possible to switch between the non-nipping state in which each driven roller 14 is separated from the driving roller 13 and the nipping conveyance state in which the driven roller 14 is in pressure contact with the driving roller 13.

As illustrated in FIG. 4, the driving roller 13 is a rubber roller attached to a driving roller shaft 301A and is connected to a pre-registration driving motor Mp (see FIG. 12) as a driving source via a belt transmission mechanism 302. The pre-registration driving motor Mp is a stepping motor and is configured to be able to change driving start and stop timings and a driving speed of the driving roller 13 (a peripheral speed of the driving roller 13).

### Detailed Configuration of Skew Feeding Correction Section

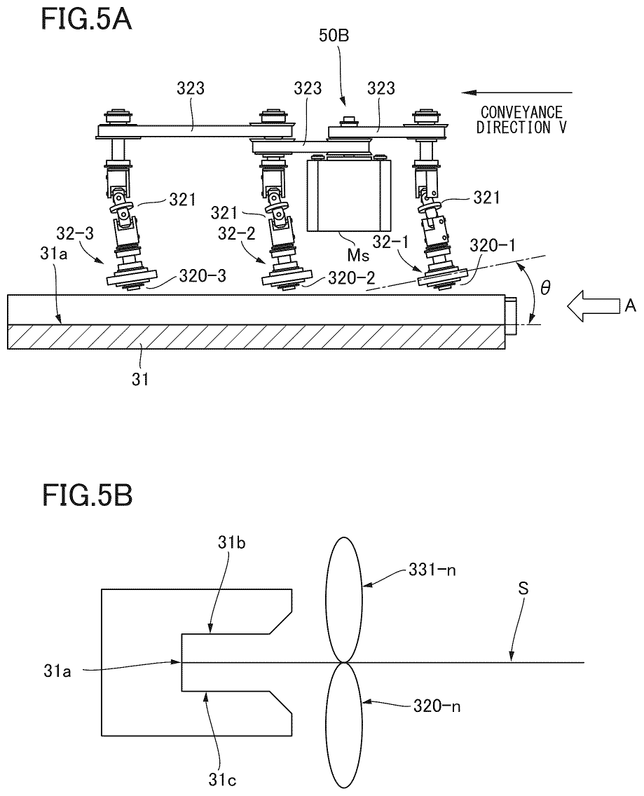

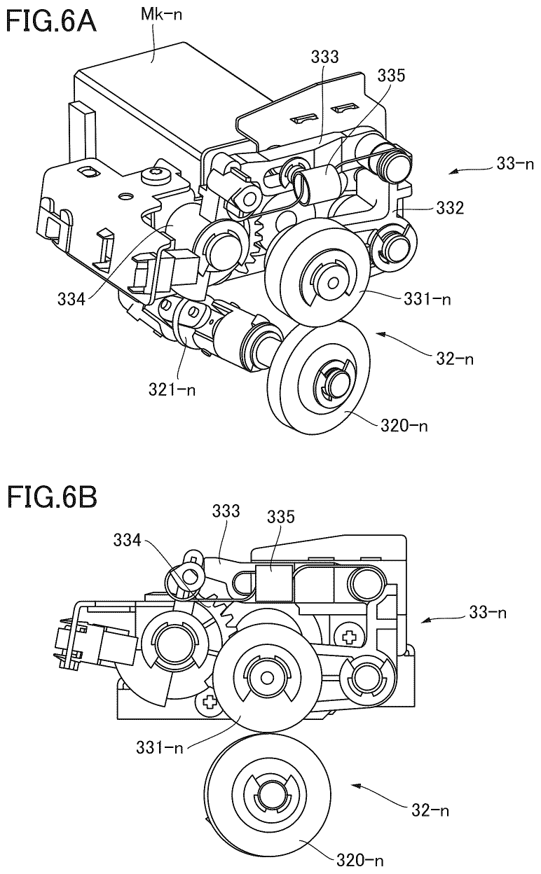

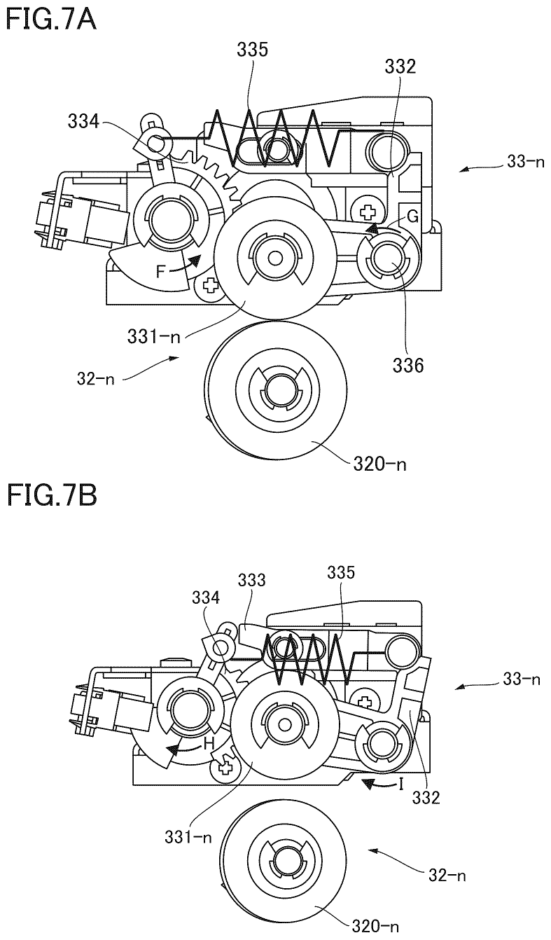

Next, a configuration of the skew feeding correction section 50B will be described in detail with reference to FIGS. 5A, 5B, 6A, 6B, 7A, and 7B. FIG. 5A is a top view illustrating a part of the skew feeding correction section in the registration unit. FIG. 5B is a cross-sectional view illustrating a part of the skew feeding correction section in the registration unit when viewed from the sheet conveyance direction. FIG. 6A is a perspective view illustrating the skewing roller pair and a pressurization mechanism of the skewing roller pair. FIG. 6B is a side view illustrating the skewing roller pair and a part of the pressurization mechanism of the skewing roller pair. FIG. 7A is a side view illustrating the skewing roller pair in a nipping conveyance state. FIG. 7B is a side view illustrating the skewing roller pair in a non-nipping state.

As illustrated in FIG. 5A, the skewing roller pairs 32-1, 32-2, and 32-3 are disposed in the skew feeding correction section 50B, and the skewing roller pairs 32-1, 32-2, and 32-3 include driving rollers 320-1, 320-2, and 330-3, respectively. Rotation axes of the driving roller 320-1, 320-2, and 330-3 are fixed by universal joints 321 in a state of being inclined at the angle θ. When it is not necessary to distinguish the driving rollers 320-1, 320-2, and 330-3, the driving rollers 320-1, 320-2, and 330-3 are referred to as a driving roller 320-n.

Each driving roller 320-n is coupled to a skewing roller driving motor Ms-n (see FIG. 12) as a driving source via a transmission mechanism including the universal joint 321, a belt 323, and a pulley. The skewing roller driving motor Ms-n is a stepping motor and can control a driving speed and a driving start/stop timing of the driving roller 320-n. That is, the driving rollers 320-1, 320-2, and 330-3 of the skewing roller pairs 32-1, 32-2, and 32-3 are rotationally driven by skewing roller driving motors Ms-1, Ms-2, and Ms-3 serving as first driving units.

As illustrated in FIG. 5B, the reference member 31 has a recessed cross section including the reference surface 31a against which the side end of the sheet S abuts, an upper facing surface 31b facing an upper side of the sheet S, and a lower facing surface 31c facing a lower side of the sheet S. The reference member 31 is formed by aluminum die casting. The reference surface 31a can be precisely finished by cutting and can be suitably subjected to electroless nickel plating with a fluororesin such as polytetrafluoroethylene (PTFE). As a result, the reference surface 31a having high flatness and high slipperiness (a low frictional resistance against the sheet) is obtained, so that accuracy of skew feeding correction of the sheet S can be improved.

As illustrated in FIGS. 6A, 6B, 7A, and 7B, the skewing roller pair 32-n disposed in the skew feeding correction section 50B includes the driving roller 320-n and a driven roller 331-n facing the driving roller 320-n. A pressurization mechanism 33-n that moves the driven roller 331-n is disposed in the skew feeding correction section 50B. The pressurization mechanism 33-n includes a pressurization mechanism 33-1 that moves the driven roller 331-1 of the skewing roller pair 32-1. Further, the pressurization mechanism 33-n includes a pressurization mechanism 33-2 that moves the driven roller 331-2 of the skewing roller pair 32-2 and a pressurization mechanism 33-3 that moves the driven roller 331-3 of the skewing roller pair 32-3. In the present embodiment, the pressurization mechanism 33-1 forms a first switching mechanism, the pressurization mechanism 33-2 forms a third switching mechanism, and the pressurization mechanism 33-3 forms a second switching mechanism. The first switching mechanism, the second switching mechanism, and the third switching mechanism form a switching unit. When it is not necessary to distinguish the pressurization mechanisms 33-1, 33-2, and 33-3, the pressurization mechanisms 33-1, 33-2, and 33-3 will be referred to as a pressurization mechanism 33-n. The pressurization mechanism 33-n can switch between the nipping conveyance state in which the driven roller 331-n is pressed against the driving roller 320-n to form a nip, and the sheet is nipped and conveyed, and the non-nipping state in which the driven roller 331-n is separated from the driving roller 320-n.

Here, n is a number obtained by numbering the skewing roller pairs 32, the driven rollers 331, and the pressurization mechanisms 33 in order from upstream in the sheet conveyance direction V. For example, the skewing roller pair 32-1 means the skewing roller pair 32 disposed on the most upstream side (n=1). That is, in the skew feeding correction section 50B of the present embodiment, a plurality of sets of driven rollers 331-n and pressurization mechanisms 33-n are disposed in a state in which the skewing roller pair 32-n illustrated in FIGS. 6A to 7B is replaced with any one of the skewing roller pairs 32-1, 32-2, and 32-3.

The pressurization mechanism 33-n includes an arm member 332, a link member 333, a pressurization gear 334, a pressurization spring 335, and a driven roller pressurization motor Mk-n (see FIG. 12). The driven roller 331-n is rotatably supported by the arm member 332 about a driven shaft and is movable in a direction of approaching or being separated from the skewing roller pair 32-n by swinging of the arm member 332. The driven roller 331-n in the present embodiment rotates in the sheet conveyance direction about an axis extending in the width direction. However, the driven roller 331-n may also be disposed on an axis parallel to the corresponding skewing roller pair 32-n. The arm member 332 is coupled to the pressurization gear 334 via the pressurization spring 335 and the link member 333. The pressurization gear 334 is coupled to an output shaft of the driven roller pressurization motor Mk-n as a drive source.

As illustrated in FIG. 7A, in the nipping conveyance state, the pressurization gear 334 rotates in a counterclockwise direction in the drawing, and the arm member 332 pulled by the pressurization spring 335 swings in the counterclockwise direction about a swing shaft 332-1. As a result, the driven roller 331-n comes into pressure contact with the driving roller 320-n. On the other hand, as illustrated in FIG. 7B, in the non-nipping state, the pressurization gear 334 rotates in a clockwise direction in the drawing to press the link member 333, and the link member 333 swings the arm member 332 in the clockwise direction. As a result, the driven roller 331-n is separated from the driving roller 320-n.

The driven roller pressurization motor Mk-n is a stepping motor, and an amount of extension of the pressurization spring 335 in a pressurized state can be changed by controlling a rotation angle of the pressurization gear 334. That is, the pressurization mechanism 33-n according to the present embodiment can switch between the nipping conveyance state and the non-nipping state and change a pressurization force in the nipping conveyance state.

### Configuration of Sheet Position Detection Sensor

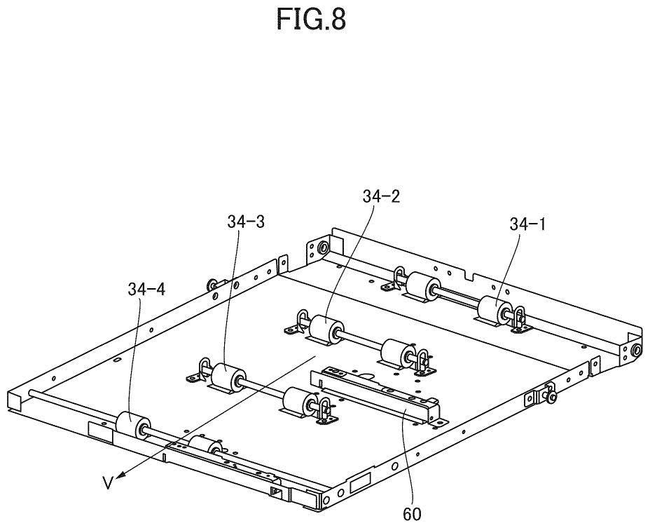

Next, a configuration of the sheet position detection sensor 60 serving as the width position detection unit of the present embodiment will be described with reference to FIG. 8. FIG. 8 is a perspective view illustrating the sheet position detection sensor in the conveyance section of the registration unit. The sheet position detection sensor 60 includes an optical element such as a contact image sensor (CIS), and is disposed on the same side as the reference member 31 with respect to the center of the sheet in the width direction based on the sheet conveyance direction V and at a position deviated in the width direction. This is to detect the position of the edge portion of the sheet on a side that abuts against the reference member 31.

### Configuration for Driving and Sliding of Conveyance Roller Pair

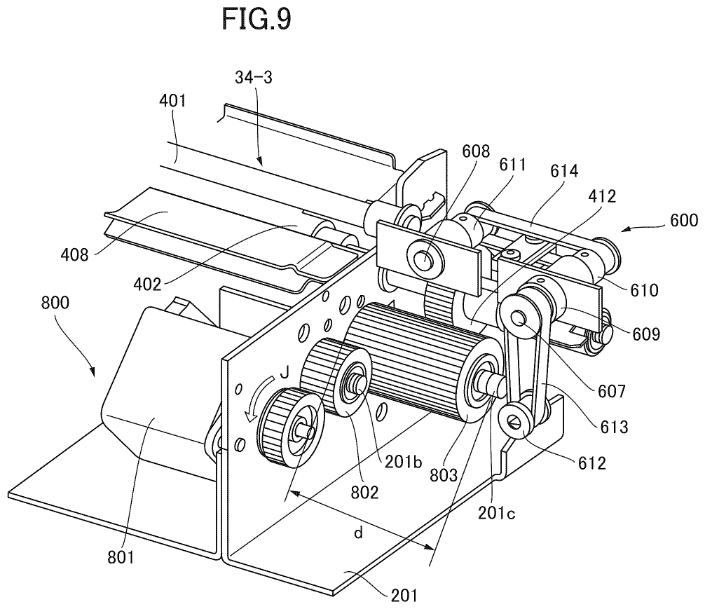

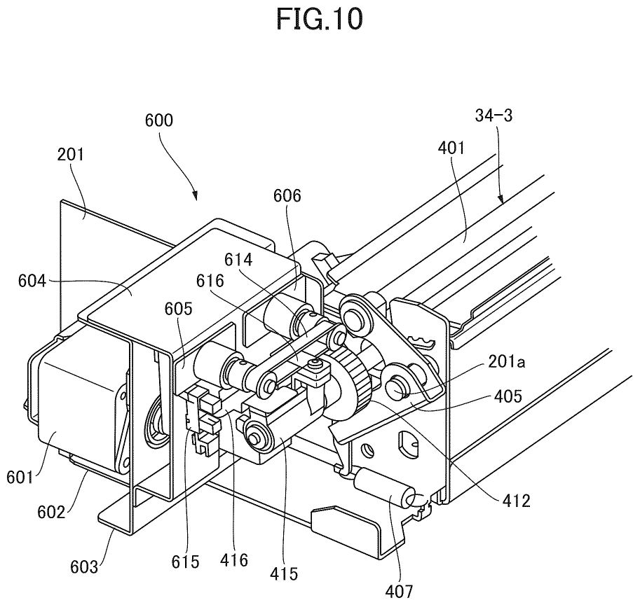

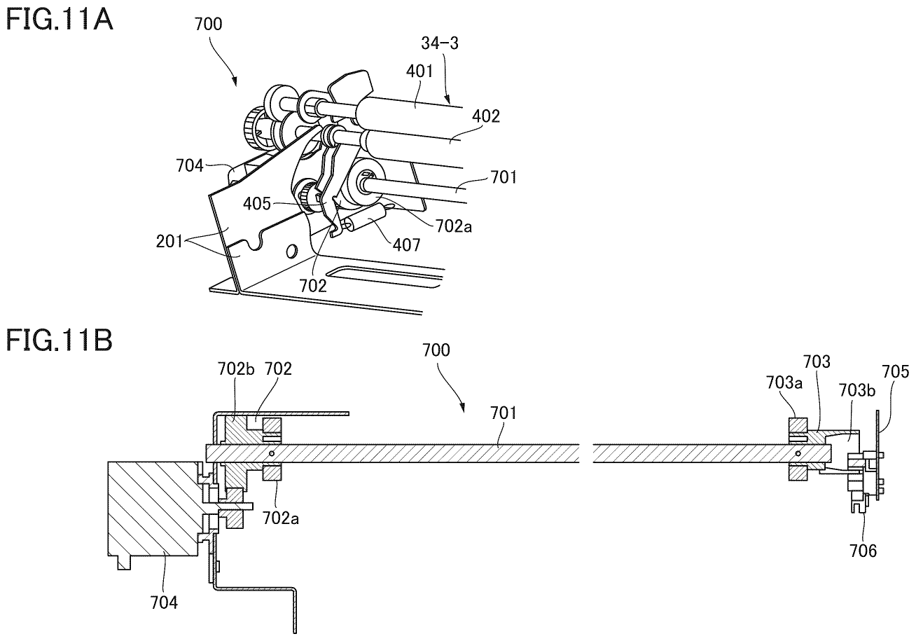

Next, a driving configuration of the conveyance roller pair 34-3 and a configuration of the sliding mechanism 600 for sliding the conveyance roller pair 34-3 in the present embodiment will be described with reference to FIGS. 9, 10, 11A, and 11B. FIG. 9 is a perspective view illustrating a driving mechanism of the conveyance roller pair in the conveyance section of the registration unit. FIG. 10 is a perspective view illustrating the sliding mechanism of the conveyance roller pair in the conveyance section of the registration unit. FIG. 11A is a perspective view illustrating a pressurization releasing mechanism of the conveyance roller pair in the conveyance section of the registration unit. FIG. 11B is a cross-sectional view illustrating the pressurization releasing mechanism of the conveyance roller pair in the conveyance section of the registration unit.

The conveyance roller pair 34-3 is roughly rotationally driven by a roller driving mechanism 800 and is configured to be movable in the width direction orthogonal to the sheet conveyance direction by the sliding mechanism 600 in a state of nipping the sheet. The conveyance roller pair 34-3 is configured to be switchable between the nipping conveyance state in which the sheet is nipped by a nip between a roller pair forming the conveyance roller pair 34-3 and the non-nipping state in which the roller pair is separated by a pressurization releasing mechanism 700 serving as a second switching mechanism.

Specifically, as illustrated in FIG. 10, the conveyance roller pair 34-3 includes an upper roller 401 and a lower roller 402 (see FIG. 11A). The lower roller 402 is rotatably supported by a frame 201 (see FIG. 11A), and the upper roller 401 is rotatably supported by a pressurization arm 405 (see FIG. 10). The pressurization arm 405 is rotatably fixed by a shaft 201a formed on the frame 201 (see FIG. 10). The upper roller 401 is pressed against the lower roller 402 by a tension spring 407. A roller gear 412 that transmits drive from the roller driving mechanism 800 to the lower roller 402 is fixed to one end of the lower roller 402 (see FIG. 9).

As illustrated in FIG. 9, the roller driving mechanism 800 that rotates the conveyance roller pair 34-3 includes a sliding roller driving motor 801 (see FIG. 12) serving as a third driving unit, driving gears 802 and 803, and the roller gear 412. The sliding roller driving motor 801 is fixed to the frame 201, and the drive of the sliding roller driving motor 801 is transmitted to the roller gear 412 via the driving gears 802 and 803. In the driving gear 803, a tooth surface of the driving gear 803 is formed to have a length d larger than a reciprocating width of the roller gear 412 so that meshing with the roller gear 412 is maintained. The driving gear 802 is rotatably fixed to a fixed shaft 201b of the frame 201, and the driving gear 803 is rotatably fixed to a fixed shaft 201c. In the present embodiment, a stepping motor is used as the sliding roller driving motor 801. With such a configuration, the drive of the sliding roller driving motor 801 is transmitted to the roller gear 412, and the conveyance roller pair 34-3 rotates.

As illustrated in FIG. 10, the sliding mechanism 600 serving as the second movement driving unit that moves the conveyance roller pair 34-3 in the width direction includes a sliding motor 601 (see FIG. 12) screwed to a motor support plate 603 in a state of being fixed to a motor base 602. A pulley support plate 604 is screwed above the motor support plate 603 in a state of having the sliding motor 601 interposed therebetween. Pulley bases 605 and 606 are fixed to the pulley support plate 604. As illustrated in FIG. 9, a pulley shaft 607 is rotatably fixed to the pulley base 605, and a pulley shaft 608 is rotatably fixed to the pulley base 606. Pulleys 609 and 610 are fixed to the pulley shaft 607, and a pulley 611 is fixed to the pulley shaft 608. Further, a pulley 612 is fixed to a distal end of an output shaft of the sliding motor 601. A timing belt 613 is stretched between the pulley 609 and the pulley 612, and a timing belt 614 is stretched between the pulley 610 and the pulley 611 (see FIG. 10).

As illustrated in FIG. 10, a holder 415 is rotatably supported by a bearing at an end portion of the lower roller 402 on a side adjacent to the roller gear 412. A sensor flag 416 that detects home positions of the upper roller 401 and the lower roller 402 of the conveyance roller pair 34-4 in the width direction is attached to the holder 415. When the upper roller 401 and the lower roller 402 of the conveyance roller pair 34-4 are at the home positions, the sensor flag 416 is detected by a sensor 615 provided on the pulley support plate 604. The holder 415 is fixed to the timing belt 614 by a stopper 616 and a screw (not illustrated). With such a configuration, the timing belt 614 rotates by driving the sliding motor 601, and the lower roller 402 of the conveyance roller pair 34-3 reciprocates in the width direction orthogonal to the sheet conveyance direction according to the rotation of the timing belt 614. The upper roller 401 of the conveyance roller pair 34-3 is engaged with the lower roller 402 by an engagement member (not illustrated) and reciprocates in the width direction orthogonal to the sheet conveyance direction together with the lower roller 402. In the present embodiment, the sliding motor 601 is driven based on a result of detecting the position of the edge portion of the sheet in the width direction by the sheet position detection sensor 60, and the conveyance roller pair 34-3 moves in the width direction.

As illustrated in FIG. 11A, the pressurization releasing mechanism 700 that causes the upper roller 401 and the lower roller 402 of the conveyance roller pair 34-3 to abut on each other and be separated from each other includes a pressurization releasing shaft 701 positioned on the frame 201. The pressurization releasing mechanism 700 includes cams 702 and 703 (see FIG. 11B) fixed to the pressurization releasing shaft 701. As illustrated in FIG. 11B, deep groove ball bearings 702a and 703a are press-fitted to the cams 702 and 703 at positions eccentric from respective rotation centers of the cams 702 and 703. As illustrated in FIG. 11A, a gear 702b is formed in the cam 702, and drive of the pressurization releasing motor 704 (see FIG. 12) is transmitted via the cam 702, so that the pressurization releasing shaft 701 rotates.

Further, the deep groove ball bearing 702a is disposed at a position where the deep groove ball bearing 702a can abut on the pressurization arm 405, and when the pressurization releasing shaft 701 is rotated once, the deep groove ball bearing 702a swings the pressurization arm 405 against a biasing force of the spring 407. By swinging the pressurization arm 405 in this manner, the upper roller 401 and the lower roller 402 can abut on each other and be separated from each other once. A pressurization arm (not illustrated) is also provided on a side of the pressurization releasing shaft 701 where the deep groove ball bearing 703a is provided in an axial direction. A sensor flag 703b is formed in the cam 703 (see FIG. 11B). When the sensor flag 703b is detected by a sensor 706 fixed to a sensor support plate 705 fixed to the frame 201, a phase of the pressurization releasing shaft 701 is determined, and rotation of the pressurization releasing motor 704 is controlled according to the phase of the pressurization releasing shaft 701. In the sensor flag 703b, phases of the cams 702 and 703 are determined so as to block the sensor 706 when the upper roller 401 and the lower roller 402 of the conveyance roller pair 34-3 abut on each other.

### Configuration for Driving and Sliding of Conveyance Roller Pair

Next, a driving configuration of the registration roller pair 7 and a configuration of the sliding mechanism for sliding the registration roller pair 7 in the present embodiment will be described. The registration roller pair 7 in the present embodiment has the same configuration as the conveyance roller pair 34-3 described above. That is, a roller driving mechanism of the registration roller pair 7 has the same configuration as the roller driving mechanism 800 of the conveyance roller pair 34-3, and the registration roller pair 7 is rotationally driven by a sliding roller driving motor 1801 serving as a second driving unit. The sliding mechanism of the registration roller pair 7 has the same configuration as the sliding mechanism 600 of the conveyance roller pair 34-3, and the registration roller pair 7 is moved in the width direction by a sliding motor 1601 serving as the first movement driving unit. A pressurization releasing mechanism that causes the registration roller pair 7 to abut and be separated also has the same configuration as the pressurization releasing mechanism 700 of the conveyance roller pair 34-3, and the registration roller pair 7 abuts and is separated (switching between the nipping conveyance state and the non-nipping state) by a pressurization releasing motor 1704. The other structure of the registration roller pair 7 is similar to that of the conveyance roller pair 34-3 described above, and thus a description thereof will be omitted.

### Configuration of Control System of Printer

Next, a configuration of a control system of the printer 1 will be described with reference to FIG. 12. FIG. 12 is a block diagram illustrating the control system of the printer according to the first embodiment.

As illustrated in FIG. 12, the registration unit 50 in the printer 1 is controlled by the control unit 9. The control unit 9 includes a central processing unit (CPU) 9a serving as a computation unit, a random access memory (RAM) 9b and a read-only memory (ROM) 9c serving as storage units, and an interface (I/O) 9d for an external device or a network.

The CPU 9a performs control based on information input via an operation unit 400 serving as a user interface and detection signals from the pre-registration sensor P and the pre-registration sensor Q described above. The detection signals from the pre-registration sensor P and the pre-registration sensor Q are input to the CPU 9a via AD conversion units 901 and 902. A detection signal from the sheet position detection sensor 60 is input to the CPU 9a via the AD conversion unit 920. The CPU 9a loads and executes a program stored in the ROM 9c or the like. The CPU 9a drives and controls a motor group (Ms, Mp, Md, Mk-n, 601, 701, 801, 1601, 1701, and 1801) which is an actuator of the registration unit 50 via drivers 903, 904, 905, 606-n, 907, 908, 909, 910, 911, and 912.

### Outline of Operation of Registration Unit

### Operation of Conveyance Section

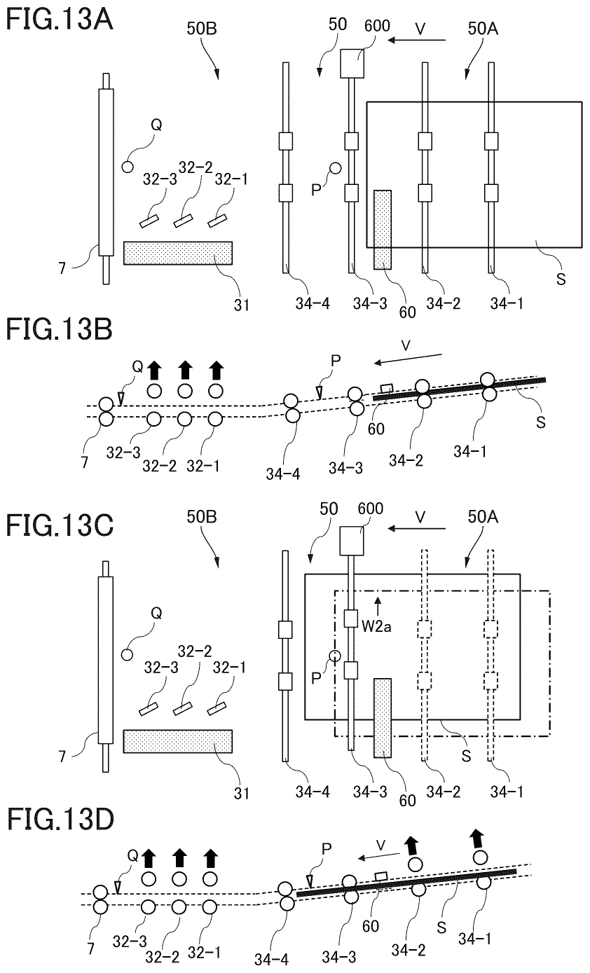

Next, an outline of an operation of the registration unit 50 will be described. First, a pre-skew-feeding-correction shift operation of the conveyance section 50A performed before skew feeding correction in the registration unit 50 will be described with reference to FIGS. 13A and 13B. FIG. 13A is a top view illustrating a state in which the sheet is conveyed to the conveyance section of the registration unit according to the first embodiment. FIG. 13B is a cross-sectional view illustrating the state illustrated in FIG. 13A. FIG. 13C is a top view illustrating a state in which the sheet is shifted by the conveyance roller pair 34-3 in the state illustrated in FIGS. 13A and 13B. FIG. 13D is a cross-sectional view illustrating the state illustrated in FIG. 13C.

As illustrated in FIGS. 13A and 13B, when the sheet S conveyed in the sheet conveyance direction V arrives at the sheet position detection sensor 60 in the registration unit 50, the position (side end position) of the edge portion of the sheet S is detected by the sheet position detection sensor 60. The CPU 9a (see FIG. 12) calculates a deviation amount from a 0-point position serving as a reference position of the sheet position detection sensor 60 based on the detected position of the side end of the sheet S, and calculates a shift amount of the conveyance roller pair 34-3 in the width direction (a shift amount of the pre-skew-feeding-correction shift operation).

Subsequently, as illustrated in FIGS. 13C and 13D, when the sheet S arrives at the conveyance roller pair 34-3 in the nipping conveyance state, the CPU 9a separates the conveyance roller pairs 34-1 and 34-2 (switches the conveyance roller pairs 34-1 and 34-2 to the non-nipping state). The CPU 9a shifts (moves) the conveyance roller pair 34-3 in a direction of an arrow W2a by the shift amount calculated above, that is, shifts the sheet S such that the side end of the sheet S is aligned with the 0-point position serving as the reference position of the sheet position detection sensor 60. In short, the 0-point position is a set position where the position of the edge portion of the sheet in the width direction is separated from the reference member 31 in the width direction. As a result, when the pre-skew-feeding-correction shift operation is completed and the sheet S is subjected to skew feeding correction by the skew feeding correction section 50B, a distance between the reference member 31 and the edge portion of the sheet S in the width direction is stabilized. That is, a sliding distance between the reference member 31 and the sheet S at the time of skew feeding correction is stabilized, so that a conveyance speed of the sheet S is stabilized.

### Operation of Skew Feeding Correction Section

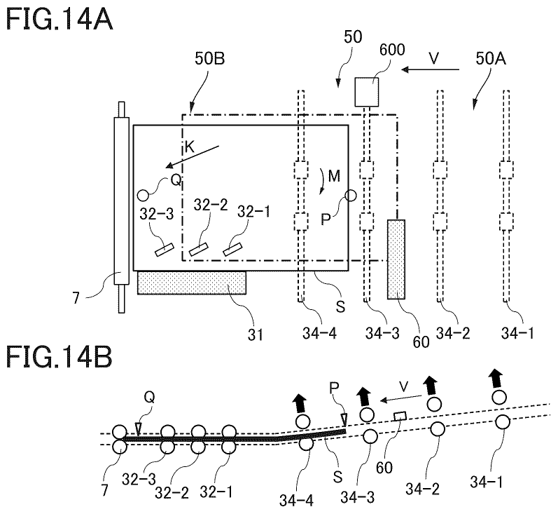

Next, a skew feeding correction operation of the skew feeding correction section 50B in the registration unit 50 will be described with reference to FIGS. 14A and 14B. FIG. 14A is a top view illustrating a state in which skew feeding correction is performed in the skew feeding correction section of the registration unit according to the first embodiment. FIG. 14B is a cross-sectional view illustrating the state illustrated in FIG. 14A.

After the pre-skew-feeding-correction shift operation of the conveyance section 50A ends, that is, after the conveyance roller pair 34-3 moves the sheet S in the width direction, the transition to the skew feeding correction operation of the skew feeding correction section 50B is made. Then, as illustrated in FIGS. 14A and 14B, in the registration unit 50, the sheet S is conveyed in a direction inclined with respect to the sheet conveyance direction V and indicated by an arrow K in the drawing by the skewing roller pairs 32-1 to 32-3 in the nipping conveyance state (pressurized state). As a result, the side end of the sheet S abuts on the reference surface 31a of the reference member 31. In the registration unit 50, when skew feeding correction is performed, the skewing roller pairs 32-1 to 32-3 are brought into the nipping conveyance state, and the conveyance roller pairs 34-1 to 34-4 are brought into the non-nipping state. Therefore, in the registration unit 50, skew feeding correction is performed by the skewing roller pairs 32-1 to 32-3 after the conveyance roller pairs 34-1 to 34-4 are separated, so that skew feeding correction can be performed without interfering with the conveyance roller pairs 34-1 to 34-4.

### Operation of Registration Roller Pair

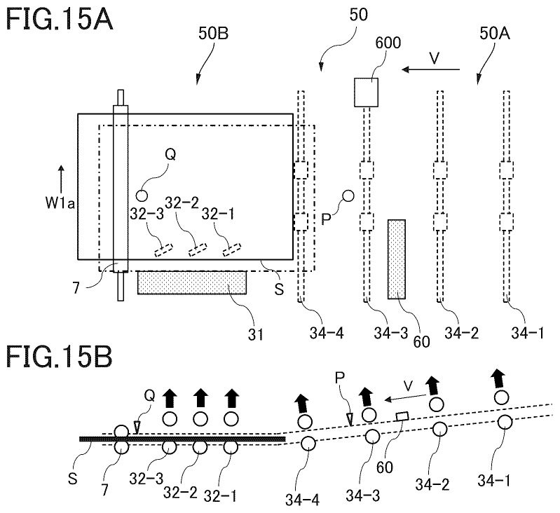

Next, a sheet alignment operation of the registration roller pair 7 in the width direction in the registration unit 50 will be described with reference to FIGS. 15A and 15B. FIG. 15A is a top view illustrating a state in which shifting is performed by the registration roller pair of the registration unit according to the first embodiment. FIG. 15B is a cross-sectional view illustrating the state illustrated in FIG. 15A.

As illustrated in FIGS. 15A and 15B, the registration roller pair 7 shifts the sheet S in a direction of an arrow W1a in the drawing such that a position of the sheet S in the width direction is aligned with the position of the image transferred at the secondary transfer portion 1C in the width direction (see FIG. 1). That is, the registration roller pair 7 performs a post-skew-feeding-correction shift operation in the direction of the arrow W1a while conveying the sheet S in the sheet conveyance direction V so as to be aligned with an image forming position in the width direction of the image to be formed on the sheet S by the image forming engine 513 (see FIG. 1). Here, the image forming position is a position at which the image is formed on the intermediate transfer belt 506. As a result, the registration unit 50 can form the image on the sheet S in a state in which the position of the sheet S subjected to skew feeding correction in the width direction is adjusted to be aligned with the position of the image formed by the image forming engine 513 and transferred at the secondary transfer portion 1C in the width direction.

In the present embodiment, after the skewing roller pairs 32-1 to 32-3 are in the non-nipping state (separated), the position of the sheet S in the width direction is shifted by the registration roller pair 7. Therefore, the position in the width direction can be shifted without interfering with the skewing roller pairs 32-1 to 32-3.

### Control of Registration Unit in Print Job

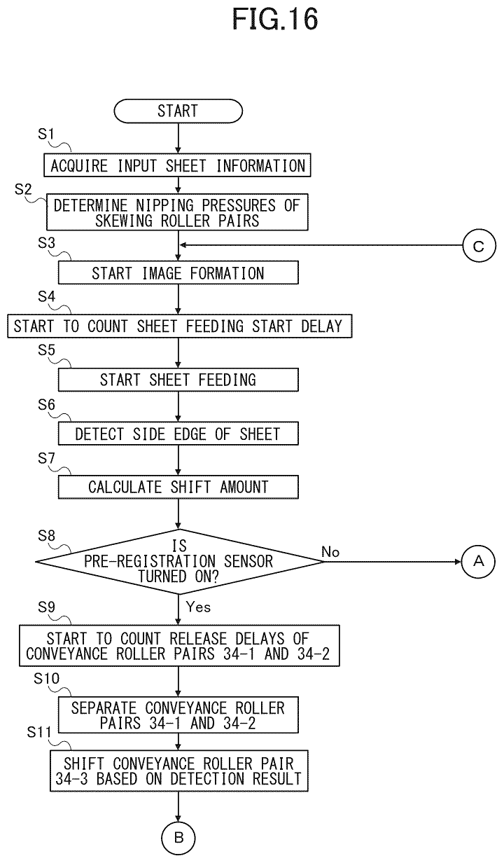

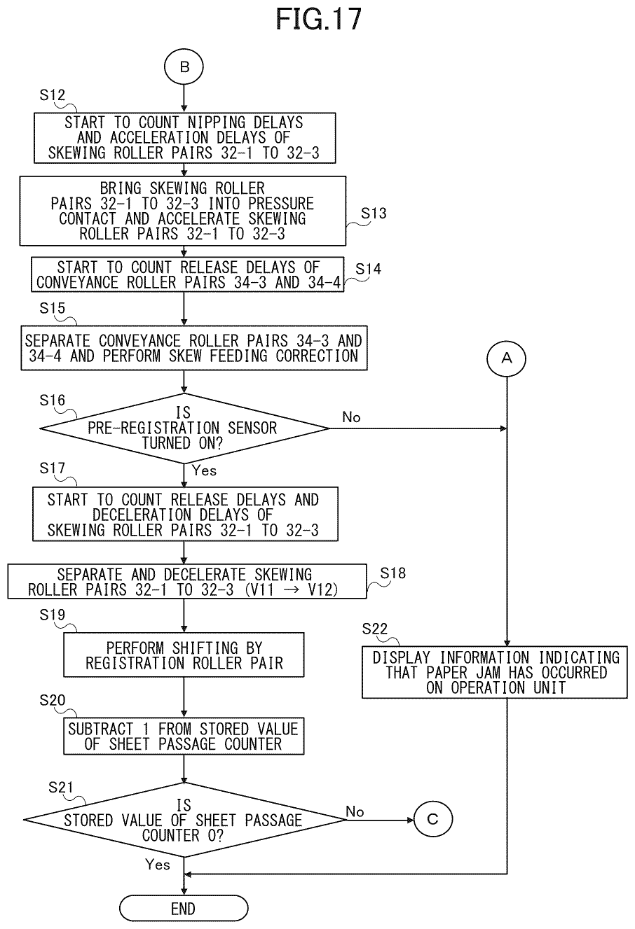

Next, for example, control in the registration unit 50 in a case where a command to perform printing of one or more sheets is transmitted from an external computer, the operation unit 400, or the like to the control unit 9, and the print job is executed will be described in detail with reference to FIGS. 16 and 17. FIG. 16 is a flowchart illustrating control of the conveyance section of the registration unit during execution of a normal print job according to the first embodiment. FIG. 17 is a flowchart illustrating control of the skew feeding correction section and the registration roller pair of the registration unit during execution of the normal print job according to the first embodiment.

### Operation of Conveyance Section of Registration Unit

First, the control unit 9 acquires information regarding the sheet (hereinafter, referred to as “sheet information”) from information included in the print job input from the external computer or the operation unit 400 (or information set in advance for the feeding cassette 51) (S1). In the processing, the control unit 9 acquires the sheet information regarding a grammage, a size, the number, and a type of the sheet. Among these pieces of sheet information, information regarding the type includes information indicating the type of the sheet, such as plain office paper, coated paper, thick paper, or thin paper. In addition, the control unit 9 acquires the number of sheets passing through the registration unit 50 in the started print job from information regarding the number of sheets included in the sheet information, and sets the acquired number as an initial value of a stored value which is a value stored in a sheet passage counter.

Next, the control unit 9 determines nipping pressures of the skewing roller pairs 32-1 to 32-3 (S2). In the processing, based on the sheet information acquired in the processing of step S1 and a determined operation mode, the control unit 9 acquires, from the ROM 9c, table data in which the nipping pressure is associated with each type of sheet set in advance, and determines the nipping pressures of the skewing roller pairs 32-1 to 32-3. A magnitude of the nipping pressure in each of the skewing roller pairs 32-1 to 32-3 is determined according to the type and the grammage of the sheet. That is, for example, the nipping pressures in the skewing roller pairs 32-1 to 32-3 are set to be larger as the grammage is larger and the surface of the sheet is more slippery.

Next, the control unit 9 starts image formation by the image forming engine 513 (S3). Furthermore, the control unit 9 starts to count a sheet feeding start delay based on a timing at which the processing of step S3 starts (S4). The sheet feeding start delay is a time difference between a time elapsed until the image formed on the intermediate transfer belt 506 is conveyed to the secondary transfer portion 1C and a time elapsed until the sheet is conveyed from the sheet cassette 51 to the secondary transfer portion 1C. The control unit 9 sets a value to be counted as the sheet feeding start delay corresponding to the image whose formation has been started in the processing of step S3, and starts counting.

At a timing at which a count value of the sheet feeding start delay reaches the set value, the control unit 9 starts sheet feeding from the sheet cassette 51 (S5). The control unit 9 causes the sheet position detection sensor 60 to detect the position of the side end of the sheet at a first timing at which the sheet arrives at the sheet position detection sensor 60 after being conveyed (S6). The arrival of the sheet at the sheet position detection sensor 60 can be detected by a signal output from the sheet position detection sensor 60.

Next, the control unit 9 calculates the shift amount for the sheet (S7). In the processing, the control unit 9 calculates the deviation amount from the 0-point position set as the reference position of the sheet position detection sensor 60 based on a detection result of the sheet position detection sensor 60. Then, the control unit 9 determines the shift amount by which the conveyance roller pair 34-3 is to be shifted in the width direction orthogonal to the sheet conveyance direction according to the calculated deviation amount.

After executing the processing of step S8, the control unit 9 determines whether or not the pre-registration sensor P is turned on (S8). In the processing, the control unit 9 determines whether or not the sheet whose position of the side end has been detected by the sheet position detection sensor 60 has arrived at the pre-registration sensor P based on the signal of the pre-registration sensor P.

In the processing of step S8, in a case where it is determined that the pre-registration sensor P is not turned on (No in S8), the control unit 9 determines that a paper jam has occurred since the sheet is not conveyed at a timing at which the sheet is to be conveyed to the pre-registration sensor P. The control unit 9 displays information indicating that the paper jam has occurred on the operation unit 400 (S22 in FIG. 17), and ends the control.

On the other hand, in a case where it is determined that the pre-registration sensor P is turned on (Yes in S8), the control unit 9 starts to count release delays of the conveyance roller pairs 34-1 and 34-2 (S9). When the processing of step S9 is executed, in the registration unit 50, the sheet arrives at the pre-registration sensor P positioned downstream of the conveyance roller pair 34-3 in the conveyance direction, and the pre-skew-feeding-correction shift operation of the conveyance roller pair 34-3 is possible. Therefore, in the processing of step S9, the control unit 9 sets values of the release delays, which are times elapsed until the conveyance roller pairs 34-1 and 34-2 are switched from the nipping conveyance state to the non-nipping state, and starts counting.

At a timing at which a count value of the release delay in step S9 reaches the set value, the control unit 9 separates the driving rollers 13 and the driven rollers 14 of the conveyance roller pairs 34-1 and 34-2 to bring the conveyance roller pairs 34-1 and 34-2 into the non-nipping state (S10). As a result, in the registration unit 50, the sheet is nipped by the conveyance roller pair 34-3 and is not nipped by the conveyance roller pairs 34-1 and 34-2.

Then, the control unit 9 shifts the conveyance roller pair 34-3 in the width direction by the shift amount corresponding to the detection result of the sheet position detection sensor 60 (S11). In the processing, the control unit 9 shifts the conveyance roller pair 34-3 by the shift amount calculated in the processing of step S7, and shifts the sheet such that a distance from the reference surface 31a of the reference member 31 to the side end of the sheet becomes a predetermined distance, that is, the position of the side end of the sheet is aligned with the 0-point position which is the reference position.

In the present embodiment, when the sheet is shifted in the width direction by the conveyance roller pair 34-3 in step S11, the sheet is shifted while being conveyed. However, in order to stabilize the shifting of the sheet, the sheet may be shifted by the conveyance roller pair 34-3 after the conveyance of the sheet is stopped, and then the conveyance of the sheet may be resumed.

### Operations of Skew Feeding Correction Section and Registration Roller Pair

Next, the processing proceeds to step S12 and subsequent steps illustrated in FIG. 17, and the transition to control of the skew feeding correction section and the registration roller pair is made. After executing the processing of step S11, as illustrated in FIG. 17, the control unit 9 starts to count nipping delays and acceleration delays of the skewing roller pairs 32-1 to 32-3 (S12). When the processing of step S12 is executed, the shifting of the sheet before skew feeding correction is completed in the registration unit 50. Further, in the registration unit 50, the skewing roller pairs 32-1 to 32-3 are in the non-nipping state in order to avoid the skewing roller pairs 32-1 to 32-3 from interfering with the shifting by the conveyance roller pair 34-3. Therefore, in the processing of step S12, the control unit 9 sets values of the nipping delays and the acceleration delays, which are times elapsed until the skewing roller pairs 32-1 to 32-3 are switched from the non-nipping state to the nipping conveyance state, and starts counting.

Next, at a timing at which the counting of the nipping delays ends, the control unit 9 brings the driving rollers 320-1 to 320-3 and the driven rollers 331-1 to 331-3 of the skewing roller pairs 32-1 to 32-3 into pressure contact with each other (S13). In addition, at a timing at which the counting of the acceleration delays ends, the control unit 9 starts the rotation of the driving rollers 320-1 to 320-3 of the skewing roller pairs 32-1 to 32-3, that is, increases rotational speeds of the skewing roller pairs 32-1 to 32-3 (S13). In the present embodiment, a case where the nipping delay and the acceleration delay are set to substantially the same values in step S12 is described. However, the rotation of the skewing roller pairs 32-1 to 32-3 may start first so that a conveyance speed does not decrease when the sheet S is nipped by the skewing roller pairs 32-1 to 32-3. The rotational speeds of the skewing roller pairs 32-1 to 32-3 are acceptably rotational speeds at which the speed in the sheet conveyance direction V does not decrease, which is described in detail below.

Subsequently, the control unit 9 starts to count release delays which are times until the conveyance roller pairs 34-3 and 34-4 are switched from the nipping conveyance state to the non-nipping state (S14). Then, at a timing at which the counting of the release delays ends, the lower rollers 402 and the upper rollers 401 of the conveyance roller pairs 34-3 and 34-4 are separated from each other, oblique conveyance by the skewing roller pairs 32-1 to 32-3 is performed, and skew feeding correction is performed (S15).

That is, by executing the processing of steps S12 to S15, in the registration unit 50, the sheet is not nipped by the conveyance roller pairs 34-1 to 34-4, and the sheet can be nipped and conveyed by the skewing roller pairs 32-1 to 32-3. In the registration unit 50, as the sheet is nipped and conveyed by the skewing roller pairs 32-1 to 32-3, skew feeding correction of the sheet conveyed in a state in which the side end of the sheet abuts on the reference surface 31a of the reference member 31 is performed.

Next, the control unit 9 determines whether or not the pre-registration sensor Q is turned on (S16). In the processing, the control unit 9 determines whether or not the sheet subjected to skew feeding correction by the skewing roller pairs 32-1 to 32-3 has arrived at the pre-registration sensor Q based on the signal of the pre-registration sensor Q.

In the processing of step S16, in a case where it is determined that the pre-registration sensor Q is not turned on (No in S16), the control unit 9 determines that a paper jam has occurred since the sheet is not conveyed at a timing at which the sheet is to be conveyed to the pre-registration sensor Q. In this case, the control unit 9 displays information indicating that the paper jam has occurred on the operation unit 400 (S22), and ends control processing related to registration correction and skew feeding correction.

On the other hand, in a case where it is determined that the pre-registration sensor Q is turned on (Yes in S16), the control unit 9 starts to count the release delays and deceleration delays of the skewing roller pairs 32-1 to 32-3 (S17). When the processing of step S17 is executed, in the registration unit 50, the leading edge of the sheet arrives at the pre-registration sensor Q positioned downstream of the skewing roller pairs 32-1 to 32-3 in the conveyance direction. Therefore, the registration roller pair 7 can convey and shift the sheet. Therefore, in the processing of step S17, the control unit 9 sets values of the release delays and the deceleration delays, which are times elapsed until the skewing roller pairs 32-1 to 32-3 are switched from the nipping conveyance state to the non-nipping state, and starts counting.

Next, at a timing at which the counting of the release delays ends, the control unit 9 separates the driving rollers 320-1 to 320-3 and the driven rollers 331-1 to 331-3 of the skewing roller pairs 32-1 to 32-3 (S18). As a result, in the registration unit 50, the sheet is nipped by the registration roller pair 7 and is not nipped by the skewing roller pairs 32-1 to 32-3. In addition, at a timing at which the counting of the deceleration delays ends, the control unit 9 decreases rotational speeds of the driving rollers 320-1 to 320-3 of the skewing roller pairs 32-1 to 32-3 (S18). In the present embodiment, a case where the nipping delay and the deceleration delay are set to substantially the same values in step S17 is described. However, when the sheet S is nipped by the registration roller pair 7 and starts to be conveyed, the separation of the skewing roller pairs 32-1 to 32-3 may start first so that the conveyance speed does not decrease when the sheet S is nipped by the skewing roller pairs 32-1 to 32-3. The decrease in rotational speeds of the skewing roller pairs 32-1 to 32-3 is described below in detail.

Next, the control unit 9 shifts the position of the sheet in the width direction after skew feeding correction by the registration roller pair 7 such that the position of the sheet in the width direction is aligned with the position of the image transferred at the secondary transfer portion 1C in the width direction (S19). In the processing, the control unit 9 shifts the position of the sheet nipped by the registration roller pair 7 in the width direction to a position corresponding to a position of the center of the image formed by the image forming engine 513 in the width direction.

Next, the control unit 9 subtracts 1 from the number of passing sheets counted by the sheet passage counter (S20). In the processing, when a series of skew feeding correction operations on one sheet, that is, the shifting before skew feeding correction, skew feeding correction, and the shifting after skew feeding correction, ends, the control unit 9 subtracts a value “1” corresponding to one sheet from the stored value of the sheet passage counter.

Then, the control unit 9 determines whether or not the stored value of the sheet passage counter is 0 (S21). In the processing, in a case where it is determined that the stored value of the sheet passage counter is not 0 (No in S21), the control unit 9 returns the processing to step S3 in order to perform the series of skew feeding correction operations for the sheet to be conveyed next in the current print job. On the other hand, in a case where it is determined that the stored value of the sheet passage counter is 0 (Yes in S21), the control unit 9 determines that the current print job has been completed and ends the control.

### Problems Caused by Relative Speed Difference between Skewing Roller Pairs and Registration Roller Pair

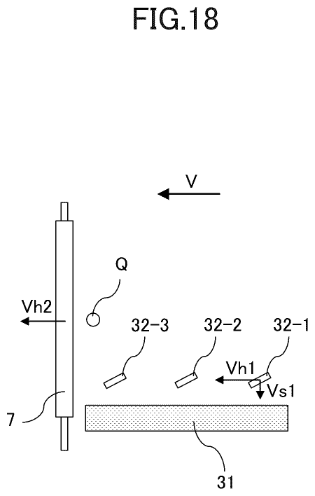

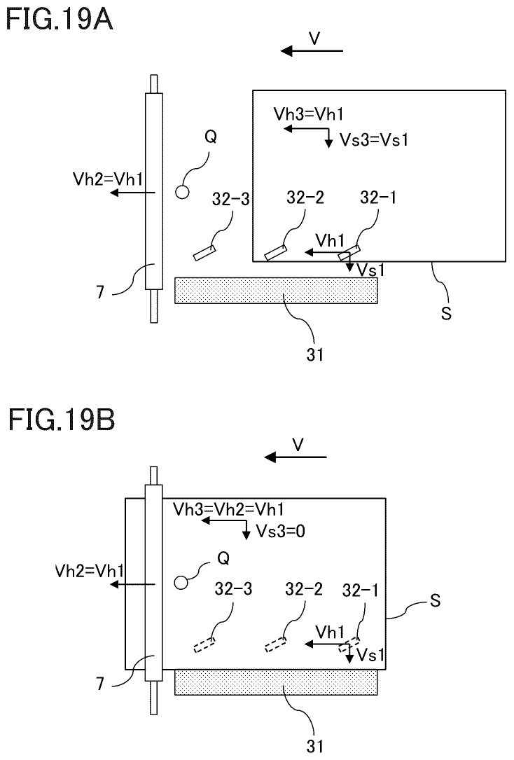

Next, problems caused by a relative speed difference between the skewing roller pairs 32-1 to 32-3 and the registration roller pair 7 will be described with reference to FIGS. 18 to 19B. FIG. 18 is a diagram illustrating a relationship between a conveyance direction speed and an abutment direction speed for the skewing roller pair and the registration roller pair. FIG. 19A is a diagram illustrating a relationship between the conveyance direction speed and the abutment direction speed for the skewing roller pair, the registration roller pair, and the sheet in a state in which the sheet is obliquely conveyed by the skewing roller pair. FIG. 19B is a diagram illustrating a relationship between the conveyance direction speed and the abutment direction speed for the skewing roller pair, the registration roller pair, and the sheet in a state in which the sheet is conveyed by the registration roller pair.

As illustrated in FIG. 18, since each of the skewing roller pairs 32-1 to 32-3 has an angle inclined with respect to the sheet conveyance direction V, each of the skewing roller pairs 32-1 to 32-3 has a conveyance direction speed Vh1 and an abutment direction speed Vs1 in a rotation state. Further, since the registration roller pair 7 is not inclined with respect to the sheet conveyance direction V, the registration roller pair 7 does not have the abutment direction speed and has only a conveyance direction speed Vh2 in a rotation state. The speeds are the same as long as the roller pairs rotate in both the nipping conveyance state and the non-nipping state in which the roller pairs are separated. In the sheet conveyance direction V, the sheet S is acceptably conveyed at the same speed as much as possible regardless of whether the sheet S is conveyed by the skewing roller pairs 32-1 to 32-3 or the registration roller pair 7. Therefore, the conveyance direction speed Vh1 of each of the skewing roller pairs 32-1 to 32-3 and the conveyance direction speed Vh2 of the registration roller pair 7 are the same as each other (Vh1=Vh2).

As illustrated in FIGS. 19A and 19B, a conveyance direction speed Vh3 and an abutment direction speed Vs3 are set as speeds of the sheet S. First, in FIG. 19A, when the skewing roller pairs 32-1 to 32-3 nip and convey the sheet S, the conveyance direction speed Vh3 of the sheet S is equal to the conveyance direction speed Vh1 of each of the skewing roller pairs 32-1 to 32-3. In this case, the abutment direction speed Vs3 of the sheet S is equal to the abutment direction speed Vs1 of each of the skewing roller pairs 32-1 to 32-3. That is, in this state, there is no relative speed difference between the sheet S and the skewing roller pairs 32-1 to 32-3.

Thereafter, as illustrated in FIG. 19B, when the release delay is set based on a timing at which the leading edge of the sheet S is detected by the pre-registration sensor Q, and the skewing roller pairs 32-1 to 32-3 are separated, the conveyance of the sheet S starts by the registration roller pair 7. In this state, the conveyance direction speed Vh3 of the sheet S is equal to the conveyance direction speed Vh2 of the registration roller pair 7. As described above, since the conveyance direction speed Vh1 of each of the skewing roller pairs 32-1 to 32-3 and the conveyance direction speed Vh2 of the registration roller pair 7 are the same each other, the conveyance direction speed Vh3 of the sheet S is also the same as the conveyance direction speed Vh1 and the conveyance direction speed Vh2 (Vh3=Vh2=Vh1).

However, in this state, the sheet S abuts against the reference member 31 and does not move in an abutment direction, and the abutment direction speed Vs3 is 0. Therefore, a relative speed difference (Vs1−Vs3) occurs between the abutment direction speed Vs3 of the sheet S and the abutment direction speed Vs1 of each of the skewing roller pairs 32-1 to 32-3. That is, slipping occurs between the sheet S and the skewing roller pairs 32-1 to 32-3 due to the relative speed difference, and thus, a sliding mark is generated particularly in thick paper whose contact pressure (abutment pressure) with the skewing roller pairs 32-1 to 32-3 is large. In addition, in the case of synthetic paper with poor transferability, even if the number of sliding marks generated by the skewing roller pairs 32-1 to 32-3 is small, transfer failure or scraping of the image formed on a first side of the sheet S occurs in the case of duplex printing. That is, for example, in a case where the roller whose pressurization is released is slid on the surface of the sheet with a relative speed difference, there is a possibility that the sliding mark remains on the surface of the sheet, and in particular, in the case of double-sided printing, there is a possibility that the image formed on the first side of the sheet is scraped off. In a configuration in which a rotation angle direction of the skewing roller and a rotation angle direction of the registration roller are different from each other, or in a configuration in which a rotation angle direction of the skewing roller on a far side and a rotation angle direction of the skewing roller on a near side are different from each other, there is a problem that the sliding mark caused by one roller may be generated in a case where pressurization of one roller is released and the sheet is conveyed by the other roller.

### Control of Rotational Speed of Skewing Roller Pair in First Embodiment

In view of the above problem, in the first embodiment, the control unit 9 sets the release delays and the deceleration delays based on the timing at which the leading edge of the sheet S is detected by the pre-registration sensor Q (see S17). Then, when (or immediately after) the skewing roller pairs 32-1 to 32-3 are separated in response to the end of the counting of the release delays and the deceleration delays, the control unit 9 decelerates the skewing roller pairs 32-1 to 32-3 (see S18). In short, the control unit 9 controls the rotational speeds of the skewing roller pairs 32-1 to 32-3 to be a first speed V11 when the sheet is obliquely conveyed to the reference member 31 by the skewing roller pairs 32-1 to 32-3. Then, when the skewing roller pairs 32-1 to 32-3 are brought into the non-nipping state and the sheet is conveyed by the registration roller pair 7, the rotational speeds of the skewing roller pairs 32-1 to 32-3 are controlled to be a second speed V12 lower than the first speed V11 (see S18). As a result, the relative speed difference (Vs1−Vs3) in abutment direction speed between the sheet S and the skewing roller pairs 32-1 to 32-3 can be reduced in a state in which the sheet S is conveyed by the registration roller pair 7. Therefore, it is possible to suppress the generation of the sliding mark of the sheet S caused by the skewing roller pairs 32-1 to 32-3 in the non-nipping state, and it is also possible to reduce the transfer failure and the scraping of the image.

When the rotation of the skewing roller pairs 32-1 to 32-3 is stopped, the conveyance direction speed Vh1 of each of the skewing roller pairs 32-1 to 32-3 becomes 0, and thus, there is a possibility that the relative speed difference (Vh3−Vh1) between the conveyance direction speed Vh3 of the sheet S and the conveyance direction speed Vh1 becomes large. Therefore, in the first embodiment, the control unit 9 sets the rotational speed of each of the skewing roller pairs 32-1 to 32-3 to fall within a range satisfying 0≤(Vh3−Vh1)≤Vs1. In particular, it is acceptable to set the rotational speed such that a relative speed difference in the conveyance direction and a relative speed difference in the abutment direction are well balanced. As a result, the relative speed difference (Vs1−Vs3) in abutment direction speed between the sheet S and the skewing roller pairs 32-1 to 32-3 can be reduced, and the relative speed difference (Vh3−Vh1) in conveyance direction speed can also be reduced. The rotational speed of each of the skewing roller pairs 32-1 to 32-3 may be set separately depending on the type of the sheet (for example, thick paper or synthetic paper) as long as the rotational speed falls within the above range. That is, according to the type of the sheet, the rotational speed of each of the skewing roller pairs 32-1 to 32-3 is acceptably set to a rotational speed that provides a high suppression effect against the generation of the sliding mark and the scraping of the image.

In the above description, a case where the sheet S is conveyed by the registration roller pair 7, and the skewing roller pairs 32-1 to 32-3 are idling in the non-nipping state has been described, but the same applies to a case where the sheet S is conveyed by the conveyance roller pairs 34-3 and 34-4. That is, also in a case where the sheet S is conveyed by the conveyance roller pairs 34-3 and 34-4 to the skewing roller pairs 32-1 to 32-3 in the non-nipping state, when the rotation of the skewing roller pairs 32-1 to 32-3 is stopped, the relative speed difference (Vh3−Vh1) in conveyance direction speed occurs. Therefore, it is conceivable to rotate the skewing roller pairs 32-1 to 32-3 such that the conveyance direction speed Vh1 becomes the same as the conveyance direction speed Vh3 of the sheet S. However, the sheet S abuts against the reference member 31 and does not move in the abutment direction, and the abutment direction speed Vs3 is 0. Therefore, there is a possibility that the relative speed difference (Vs1−Vs3) occurs between the abutment direction speed Vs3 of the sheet S and the abutment direction speed Vs1 of each of the skewing roller pairs 32-1 to 32-3.

Therefore, also in this case, it is conceivable that, when the skewing roller pairs 32-1 to 32-3 are brought into the non-nipping state and the sheet is conveyed by the conveyance roller pair 34-3, the control unit 9 controls the rotational speeds of the skewing roller pairs 32-1 to 32-3 to be a third speed lower than the first speed. Here, when the skewing roller pairs 32-1 to 32-3 rotate such that the conveyance direction speed Vh1 is equal to the conveyance direction speed Vh3 of the sheet S, there is a possibility that the relative speed difference (Vs1−Vs3) in abutment direction speed becomes large. Therefore, even in this case, the control unit 9 sets the rotational speeds of the skewing roller pairs 32-1 to 32-3 to fall within a range satisfying 0≤(Vh3−Vh1)≤Vs1. In particular, it is acceptable to set the rotational speed such that a relative speed difference in the conveyance direction and a relative speed difference in the abutment direction are well balanced. As a result, the relative speed difference (Vs1−Vs3) in abutment direction speed between the sheet S and the skewing roller pairs 32-1 to 32-3 can be reduced, and the relative speed difference (Vh3−Vh1) in conveyance direction speed can also be reduced. The third speed may be the same speed as the second speed.

In the above description, a case where it is assumed that the rotational speed (conveyance direction speed Vh2) of the registration roller pair 7 is constant has been described. However, it is necessary to adjust the speed of the sheet according to a timing at which the toner image transferred onto the intermediate transfer belt 506 arrives at the secondary transfer portion 1C according to the timing at which the sheet S arrives at the registration roller pair 7. Therefore, the rotational speed of the registration roller pair 7 may be changed according to the timing at which the toner image arrives at the secondary transfer portion 1C. In this case, the conveyance direction speed Vh3 of the sheet S is also changed, and thus, it is acceptable that the rotational speeds of the skewing roller pairs 32-1 to 32-3 are also changed according to a speed change ratio. Here, a ratio between the rotational speed of the conveyance roller pair 34-3 and the rotational speeds of the skewing roller pairs 32-1 to 32-3 when a downstream end of the sheet conveyed by the conveyance roller pair 34-3 in the sheet conveyance direction V is positioned downstream of the skewing roller pairs 32-1 to 32-3 and the skewing roller pairs 32-1 to 32-3 are in the non-nipping state is defined as a first ratio. A ratio between the rotational speed of the conveyance roller pair 34-3 and the rotational speeds of the skewing roller pairs 32-1 to 32-3 when an upstream end of the sheet conveyed by the skewing roller pairs 32-1 to 32-3 in the sheet conveyance direction V is positioned upstream of the conveyance roller pair 34-3 and the conveyance roller pair 34-3 is in the non-nipping state is defined as a second ratio. The control unit 9 performs control such that the first ratio and the second ratio are different from each other.

### Second Embodiment

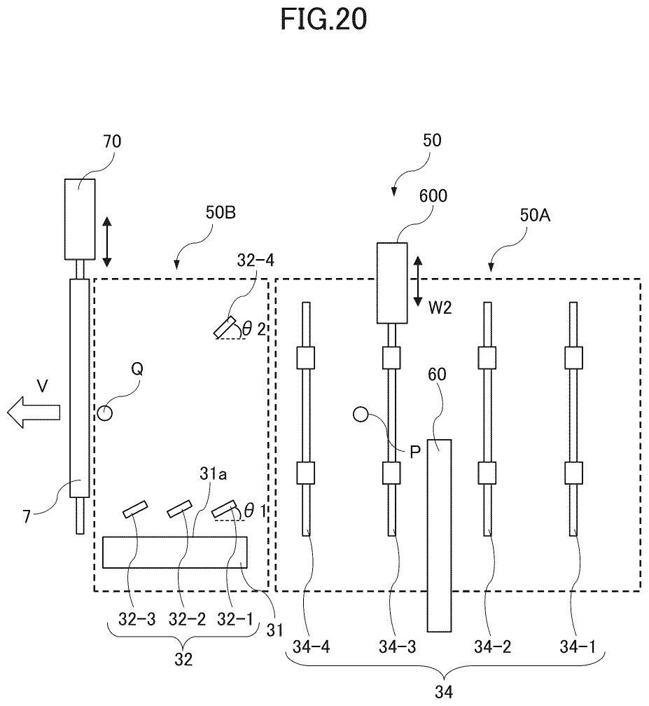

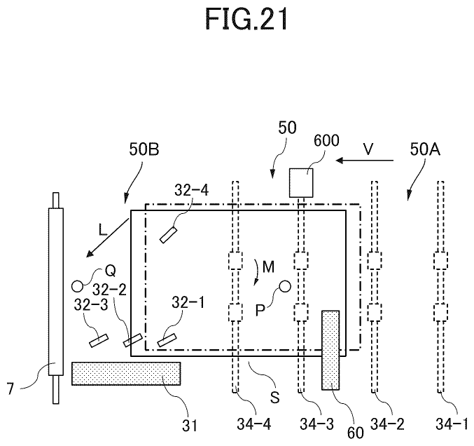

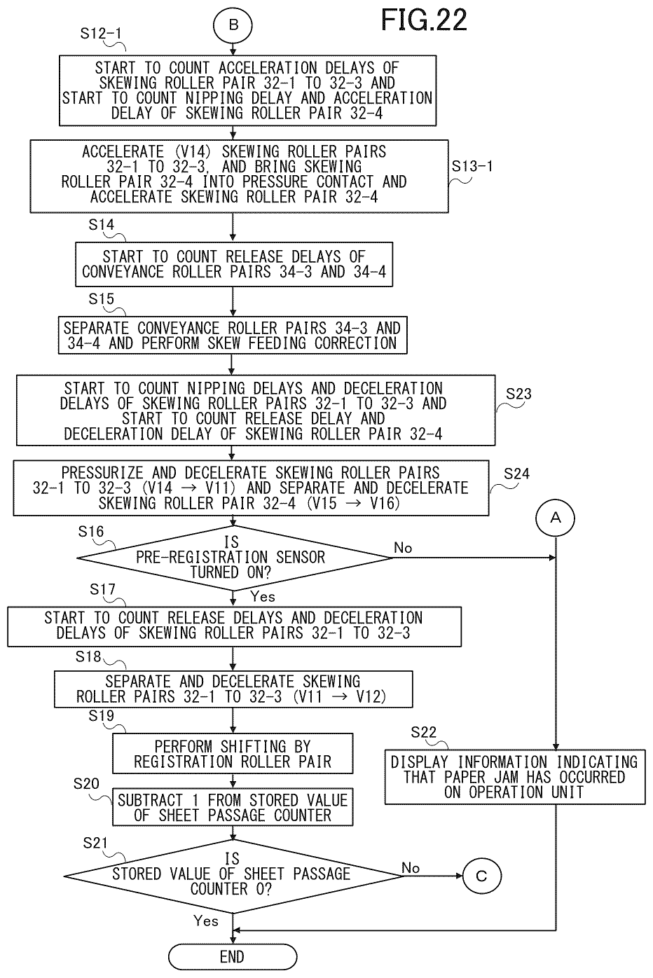

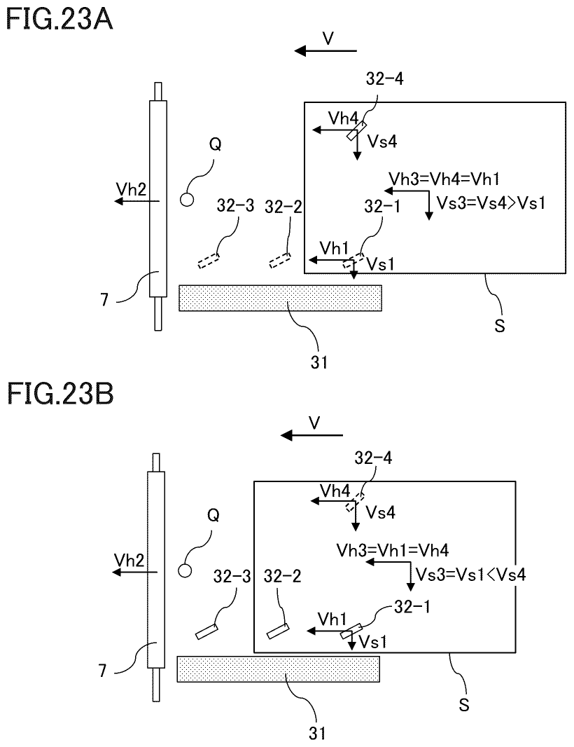

Next, a second embodiment partially modified from the first embodiment will be described with reference to FIGS. 20 to 23B. FIG. 20 is a top view illustrating a registration unit according to the second embodiment. FIG. 21 is a top view illustrating a state in which a sheet is skew-fed by a skewing roller pair 32-4 in a skew feeding correction section of the registration unit according to the second embodiment. FIG. 22 is a flowchart illustrating control of the skew feeding correction section and a registration roller pair of the registration unit during execution of a normal print job according to the second embodiment. FIG. 23A is a diagram illustrating a relationship between a conveyance direction speed and an abutment direction speed for the skewing roller pair 32-4, a skewing roller pair 32-1, and the sheet in a state in which the sheet is obliquely conveyed by the skewing roller pair 32-4 in the second embodiment. FIG. 23B is a diagram illustrating a relationship between the conveyance direction speed and the abutment direction speed for the skewing roller pair 32-4, the skewing roller pair 32-1, and the sheet in a state in which the sheet is obliquely conveyed by the skewing roller pair 32-1 in the second embodiment. In the description of the second embodiment, the same reference numerals are used for the same parts as those of the first embodiment, and a description thereof will be omitted.

### Configuration of Registration Unit According to Second Embodiment

A registration unit 50 included in a sheet conveyance apparatus according to the second embodiment is different from that of the first embodiment in that the skewing roller pair 32-4 is provided. The skewing roller pair 32-4 is an example of a second skewing rotary member pair. The skewing roller pair 32-4 is disposed at a position farther (more distance) from the reference member 31 than the skewing roller pairs 32-1 to 32-3 in a width direction. That is, in a printer 1, the skewing roller pairs 32-1 to 32-3 are disposed on a near side, and the skewing roller pair 32-4 is disposed on a far side. Therefore, the skewing roller pair 32-4 obliquely conveys the sheet toward the skewing roller pairs 32-1 to 32-3. The skewing roller pair 32-4 is disposed such that a tangential direction at a contact portion for the sheet is a direction inclined at an angle θ2 with respect to a sheet conveyance direction V. The angle θ2 is larger than an angle θ1 of a tangential direction of a contact portion of each of the skewing roller pairs 32-1 to 32-3 with respect to the sheet conveyance direction V. In other words, the skewing roller pair 32-4 has a larger angle in an oblique conveyance direction with respect to the reference member 31 than the skewing roller pairs 32-1 to 32-3, that is, the skewing roller pair 32-4 is disposed such that the sheet is moved toward the reference member 31 to a greater extent than the skewing roller pairs 32-1 to 32-3. Therefore, the skewing roller pair 32-4 is configured such that the abutment direction speed becomes larger than those of the skewing roller pairs 32-1 to 32-3, for example, if rotational speeds are the same. That is, the skewing roller pair 32-4 is disposed at a position such that the skewing roller pairs 32-1 to 32-3 are positioned between the skewing roller pair 32-4 and the reference member 31 in the width direction. Also, the skewing roller pair 32-4 is disposed at the position such that an angle between an oblique conveyance direction of the skewing roller pair 32-4 and the sheet conveyance direction V is larger than an angle between an oblique conveyance direction of the skewing roller pairs 32-1 to 32-3 and the sheet conveyance direction V. By mounting the skewing roller pair 32-4 having a large angle as described above, it is possible to assist skew feeding correction for a sheet having a large conveyance resistance, which makes it difficult to perform skew feeding correction only with the skewing roller pairs 32-1 to 32-3. Other configurations of the skewing roller pair 32-4 are similar to those of the skewing roller pairs 32-1 to 32-3. That is, a driving roller 320-4 (320-n), a driven roller 331-4 (331-n), a pressurization mechanism 33-4 (33-n) serving as a fourth switching mechanism, and a skewing roller driving motor Ms-4 (Ms-n) serving as a fourth driving unit are similar to those of the skewing roller pairs 32-1 to 32-3. Therefore, a description of such structures will be omitted.

### Operation of Registration Unit

An outline of an operation of the registration unit 50 according to the second embodiment including the skewing roller pair 32-4 will be described. As illustrated in FIG. 21, before the sheet arrives at a skew feeding correction section 50B, the skewing roller pair 32-4 is brought into a nipping conveyance state by a pressurization mechanism (not illustrated). When the sheet conveyed from a conveyance section 50A is nipped by the skewing roller pair 32-4, the sheet is conveyed in a direction of an arrow L. In this manner, first, a sheet S is obliquely conveyed such that the sheet S is moved toward the reference member 31 only with the skewing roller pair 32-4 having a large angle. Then, the sheet S is nipped by the skewing roller pairs 32-1 to 32-3, and the skewing roller pair 32-4 is separated and brought into a non-nipping state. Thereafter, as in the first embodiment, the sheet S abuts against the reference member 31 by the skewing roller pairs 32-1 to 32-3, skew feeding is corrected, and the sheet S is conveyed to a registration roller pair 7.

### Control of Skew Feeding Correction Section and Registration Roller Pair

Next, control of the skew feeding correction section and the registration roller pair in the second embodiment will be described in detail with reference to FIG. 22. The control illustrated in FIG. 22 is performed following control of an operation of the conveyance section 50A of the registration unit 50 described in the first embodiment (see FIG. 16). Since the operation of the conveyance section 50A is similar, a description thereof will be omitted.

After executing the processing of step S11 of FIG. 16, as illustrated in FIG. 22, a control unit 9 starts to count acceleration delays of the skewing roller pairs 32-1 to 32-3 and starts to count a nipping delay and an acceleration delay of the skewing roller pair 32-4 (S12-1). When the processing of step S12-1 is executed, shifting of the sheet before skew feeding correction is completed in the registration unit 50. Further, in the registration unit 50, the skewing roller pairs 32-1 to 32-4 are in the non-nipping state in order to avoid the skewing roller pairs 32-1 to 32-4 from interfering with shifting by a conveyance roller pair 34-3. Therefore, in the processing of step S12-1, the control unit 9 sets values of the nipping delay and the acceleration delay, which are times elapsed until the skewing roller pair 32-4 is switched from the non-nipping state to the nipping conveyance state, and starts counting. In addition, when the skewing roller pair 32-4 nips the sheet S and starts conveyance, if rotation of the skewing roller pairs 32-1 to 32-3 is stopped, there is a possibility that a relative rotation difference between the skewing roller pair 32-4 and the skewing roller pairs 32-1 to 32-3 becomes large. Therefore, in the processing of step S12-1, the control unit 9 sets count values of the acceleration delays of the skewing roller pairs 32-1 to 32-3 and starts counting. The rotational speeds of the skewing roller pairs 32-1 to 32-3 at this time are described below in detail.

Next, at a timing at which the counting of the acceleration delays of the skewing roller pairs 32-1 to 32-3 ends, rotation of driving rollers 320-1 to 320-3 of the skewing roller pairs 32-1 to 32-3 is started, and the rotational speeds of the skewing roller pairs 32-1 to 32-3 are increased (S13-1). The driving roller 320-4 and the driven roller 331-4 of the skewing roller pair 32-4 are brought into pressure contact with each other at a timing at which the counting of the nipping delay of the skewing roller pair 32-4 ends (S13-1). Further, at a timing at which the counting of the acceleration delay of the skewing roller pair 32-4 ends, the rotation of the driving roller 320-4 of the skewing roller pair 32-4 is started, that is, the rotational speed of the skewing roller pair 32-4 is increased (S13-1). In the present embodiment, a case where the nipping delay and the acceleration delay of the skewing roller pair 32-4 are set to substantially the same values in step S12-1 is described. However, the rotation of the skewing roller pair 32-4 may start first so that a conveyance speed does not decrease when the sheet S is nipped by the skewing roller pair 32-4. The rotational speed of the skewing roller pair 32-4 is acceptably a rotational speed at which the speed in the sheet conveyance direction V does not decrease, which is described in detail below.

Subsequently, the control unit 9 starts to count release delays which are times until the conveyance roller pairs 34-3 and 34-4 are switched from the nipping conveyance state to the non-nipping state (S14). Then, at a timing at which the counting of the release delays ends, the lower rollers 402 and the upper rollers 401 of the conveyance roller pairs 34-3 and 34-4 are separated from each other, oblique conveyance by the skewing roller pairs 32-1 to 32-4 is performed, and skew feeding correction is performed (S15).

That is, by executing the processing of steps S12 to S15, in the registration unit 50, the sheet is not nipped by the conveyance roller pairs 34-1 to 34-4, and the sheet can be nipped and conveyed by the skewing roller pairs 32-1 to 32-4. In the registration unit 50, after the sheet is nipped and conveyed by the skewing roller pair 32-4, the sheet is nipped and conveyed by the skewing roller pairs 32-1 to 32-3. As a result, skew feeding correction is performed on the sheet conveyed in a state in which a side end of the sheet abuts on a reference surface 31a of the reference member 31.

Next, the control unit 9 starts to count nipping delays and deceleration delays of the skewing roller pairs 32-1 to 32-3 and starts to count a release delay and a deceleration delay of the skewing roller pair 32-4 (S23). When the processing of step S23 is executed, in the registration unit 50, the skewing roller pair 32-4 starts oblique conveyance of the sheet, and the skewing roller pairs 32-1 to 32-3 are in the non-nipping state. Therefore, in the processing of step S23, the control unit 9 sets values of the release delay and the deceleration delay, which are times elapsed until the skewing roller pair 32-4 is switched from the nipping conveyance state to the non-nipping state, and starts counting. In addition, when the skewing roller pairs 32-1 to 32-3 nip the sheet S and start conveyance, if the rotation of the skewing roller pair 32-4 is stopped, there is a possibility that a relative rotation difference between the skewing roller pair 32-4 and the skewing roller pairs 32-1 to 32-3 becomes large. Therefore, in the processing of step S23, the control unit 9 sets a count value of the deceleration delay of the skewing roller pair 32-4 and starts counting. Furthermore, in step S13-1 described above, since the rotational speeds of the skewing roller pairs 32-1 to 32-3 are increased before the sheet S is nipped, count values of the deceleration delays of the skewing roller pairs 32-1 to 32-3 are set, and counting starts. Details of the rotational speeds of the skewing roller pairs 32-1 to 32-3 and the skewing roller pair 32-4 at this time are described below.

Subsequently, the driving rollers 320-1 to 320-3 and the driven rollers 331-1 to 331-3 of the skewing roller pairs 32-1 to 32-3 are brought into pressure contact with each other at a timing at which the counting of the nipping delays of the skewing roller pairs 32-1 to 32-3 ends (S24). Further, rotational speeds of the driving rollers 320-1 to 320-3 of the skewing roller pairs 32-1 to 32-3 are decreased at a timing at which the counting of the deceleration delays of the skewing roller pairs 32-1 to 32-3 ends (S24). Further, a lower roller 402 and an upper roller 401 of the skewing roller pair 32-4 are separated from each other at a timing at which the counting of the release delay of the skewing roller pair 32-4 ends (S24). A rotational speed of the driving roller 320-4 of the skewing roller pair 32-4 is decreased at a timing at which the counting of the deceleration delay of the skewing roller pair 32-4 ends (S24). In the present embodiment, a case where the nipping delays and the deceleration delays of the skewing roller pairs 32-1 to 32-3 and the release delay and the deceleration delay of the skewing roller pair 32-4 are set to substantially the same values in step S23 is described. However, the rotational speeds of the skewing roller pairs 32-1 to 32-3 may start to be decreased before nipping so that the conveyance speed does not increase when the sheet S is nipped by the skewing roller pairs 32-1 to 32-3. Further, the separation of the skewing roller pair 32-4 may start before deceleration so that the conveyance speed does not decrease before the sheet S is nipped by the skewing roller pairs 32-1 to 32-3.

The subsequent control in steps S16 to S22, that is, skew feeding correction for skew feeding by the skewing roller pairs 32-1 to 32-3 and a shift operation of the registration roller pair 7 are the same as those in the first embodiment described above (see FIG. 17), and thus a description thereof will be omitted.

### Problems Caused by Relative Speed Difference Between Skewing Roller Pairs 32-1 To 32-3 and Skewing Roller Pair 32-4

Next, problems caused by a relative speed difference between the skewing roller pairs 32-1 to 32-3 and the skewing roller pair 32-4 will be described with reference to FIGS. 23A and 23B.

As illustrated in FIGS. 23A and 23B, since the skewing roller pair 32-4 has an angle inclined with respect to the sheet conveyance direction V, the skewing roller pair 32-4 has a conveyance direction speed Vh4 and an abutment direction speed Vs4 in a rotation state. Notations of the rotational speeds of the skewing roller pairs 32-1 to 32-3 and the registration roller pair 7 are the same as those in the first embodiment.

As illustrated in FIG. 23A, when the sheet S is conveyed to the skew feeding correction section 50B, the skewing roller pair 32-4 is in the nipping conveyance state, and the skewing roller pairs 32-1 to 32-3 are in the non-nipping state. In this case, a conveyance direction speed Vh3 of the sheet S is controlled to be constant, that is, the conveyance direction speed Vh4 of the skewing roller pair 32-4 is the same as the conveyance direction speed Vh3. Since the sheet S is conveyed by the skewing roller pair 32-4, an abutment direction speed Vs3 of the sheet S is also the same as the abutment direction speed Vs4 of the skewing roller pair 32-4.

Here, for example, when the rotation of the skewing roller pairs 32-1 to 32-3 is stopped, large relative speed differences from the conveyance direction speed Vh4 and the abutment direction speed Vs4 of the skewing roller pair 32-4 occur. Therefore, it is conceivable to set the rotational speeds of the skewing roller pairs 32-1 to 32-3 such that a conveyance direction speed Vh1 of the skewing roller pairs 32-1 to 32-3 becomes the same as the conveyance direction speed Vh4 of the skewing roller pair 32-4 (Vh3=Vh4=Vh1). However, the angle θ2 of the skewing roller pair 32-4 with respect to the sheet conveyance direction V is larger than the angle θ1 of the skewing roller pair 32-1 with respect to the sheet conveyance direction V. Therefore, the abutment direction speed Vs4 of the skewing roller pair 32-4 becomes higher than the abutment direction speed Vs1 of each of the skewing roller pairs 32-1 to 32-3 (Vs3=Vs4>Vs1), and a relative speed difference (Vs4−Vs1) occurs in an abutment direction. Therefore, similarly to the problems of the first embodiment, there is a possibility that a sliding mark occurs in thick paper, or transfer failure or scraping of the image occurs in synthetic paper with poor transferability.

As illustrated in FIG. 23B, a state in which the sheet S is conveyed by the skewing roller pair 32-4 transitions to a state in which the sheet S is conveyed by the skewing roller pairs 32-1 to 32-3. Then, the skewing roller pair 32-4 is in the non-nipping state, and the skewing roller pairs 32-1 to 32-3 are in the nipping conveyance state. In this case, the conveyance direction speed Vh3 of the sheet S is controlled to be constant, that is, the conveyance direction speed Vh1 of the skewing roller pairs 32-1 to 32-3 is the same as the conveyance direction speed Vh3. Since the sheet S is conveyed by the skewing roller pairs 32-1 to 32-3, the abutment direction speed Vs3 of the sheet S is also the same as the abutment direction speed Vs1 of each of the skewing roller pairs 32-1 to 32-3.

Here, for example, when the rotation of the skewing roller pair 32-4 is stopped, large relative speed differences from the conveyance direction speed Vh1 and the abutment direction speed Vs1 of each of the skewing roller pairs 32-1 to 32-3 occur. Therefore, it is conceivable to set the rotational speed of the skewing roller pair 32-4 such that the conveyance direction speed Vh4 of the skewing roller pair 32-4 becomes the same as the conveyance direction speed Vh1 of the skewing roller pairs 32-1 to 32-3 (Vh3=Vh1=Vh4). However, the angle θ2 of the skewing roller pair 32-4 with respect to the sheet conveyance direction V is larger than the angle θ1 of the skewing roller pair 32-1 with respect to the sheet conveyance direction V. Therefore, the abutment direction speed Vs1 of each of the skewing roller pairs 32-1 to 32-3 becomes lower than the abutment direction speed Vs4 of the skewing roller pair 32-4 (Vs3=Vs1<Vs4), and a relative speed difference (Vs1−Vs4) occurs in the abutment direction. Therefore, similarly to the problems of the first embodiment, there is a possibility that a sliding mark occurs in thick paper, or transfer failure or scraping of the image occurs in synthetic paper with poor transferability.

### Control of Rotational Speed of Skewing Roller Pairs in Second Embodiment

In view of the above problems, in the second embodiment, control is performed as follows. First, when the sheet S is conveyed by the skewing roller pair 32-4 based on a timing at which a leading edge of the sheet S is detected by a pre-registration sensor P, the control unit 9 sets the acceleration delays of the skewing roller pairs 32-1 to 32-3 (see S12-1). Then, when (or immediately after) the skewing roller pair 32-4 is brought into pressure contact in response to the end of the counting of the acceleration delays, the control unit 9 accelerates the skewing roller pairs 32-1 to 32-3 such that the rotational speeds become higher than that of the skewing roller pair 32-4 (see S13-1). In short, the control unit 9 controls the rotational speeds of the skewing roller pairs 32-1 to 32-3 to be a first speed V11 when the sheet is obliquely conveyed to the reference member 31 by the skewing roller pairs 32-1 to 32-3. Then, when the skewing roller pairs 32-1 to 32-3 are brought into the non-nipping state and the sheet S is obliquely conveyed to the skewing roller pairs 32-1 to 32-3 by the skewing roller pair 32-4, the rotational speeds of the skewing roller pairs 32-1 to 32-3 are controlled to be a fourth speed V14 higher than the first speed V11 (see S13-1). As a result, the relative speed difference (Vs4−Vs1) in abutment direction speed between the skewing roller pair 32-4 and the skewing roller pairs 32-1 to 32-3 can be reduced in a state in which the sheet S is conveyed by the skewing roller pair 32-4. Therefore, it is possible to suppress the generation of the sliding mark of the sheet S caused by the skewing roller pairs 32-1 to 32-3 in the non-nipping state, and it is also possible to reduce the transfer failure and the scraping of the image.

Thereafter, the transition to a state in which the skewing roller pair 32-4 is separated and the sheet S is conveyed by the skewing roller pairs 32-1 to 32-3 in a state of being nipped by the skewing roller pairs 32-1 to 32-3 is made. In this case, since the skewing roller pairs 32-1 to 32-3 have the rotational speeds (fourth speed V14) higher than that of the skewing roller pair 32-4, the deceleration delays of the skewing roller pairs 32-1 to 32-3 are set (see S23). When the skewing roller pairs 32-1 to 32-3 are brought into pressure contact in response to the end of the counting of the deceleration delays, the skewing roller pairs 32-1 to 32-3 are decelerated to the first speed V11 such that the rotational speeds of the skewing roller pairs 32-1 to 32-3 become the conveyance direction speed Vh1 (see S24). As a result, the conveyance direction speed Vh3 of the sheet S is controlled to be constant.

Further, when the sheet S is conveyed by the skewing roller pairs 32-1 to 32-3, the control unit 9 sets the deceleration delay of the skewing roller pair 32-4 (see S23). When (or immediately after) the skewing roller pairs 32-1 to 32-3 are brought into pressure contact in response to the end of the counting of the deceleration delay, the control unit 9 decelerates the skewing roller pair 32-4 such that the rotational speed becomes lower than those of the skewing roller pairs 32-1 to 32-3 (see S24). In short, the control unit 9 controls the rotational speed of the skewing roller pair 32-4 to be a fifth speed V15 when the sheet is obliquely conveyed to the skewing roller pairs 32-1 to 32-3 by the skewing roller pair 32-4. Then, when the skewing roller pair 32-4 is brought into the non-nipping state and the sheet is obliquely conveyed to the reference member 31 by the skewing roller pairs 32-1 to 32-3, the rotational speed of the skewing roller pair 32-4 is controlled to be a sixth speed V16 lower than the fifth speed V15 (see S24). The fifth speed may be the same speed as the first speed. As a result, the relative speed difference (Vs1−Vs4) in abutment direction speed between the skewing roller pairs 32-1 to 32-3 and the skewing roller pair 32-4 can be reduced in a state in which the sheet S is conveyed by the skewing roller pairs 32-1 to 32-3. Therefore, it is possible to suppress the generation of the sliding mark of the sheet S caused by the skewing roller pair 32-4 in the non-nipping state, and it is also possible to reduce the transfer failure and the scraping of the image.

Thereafter, the skewing roller pairs 32-1 to 32-3 are separated, and the sheet S is conveyed in a state of being nipped by the registration roller pair 7. In this case, since the control is similar to the control described in the first embodiment, a description thereof will be omitted.

In addition, other configurations, operations, and effects in the second embodiment are similar to those in the first embodiment, and thus a description thereof will be omitted.

### Possibility of Other Embodiments

In the first embodiment described above, the registration unit 50 includes three skewing roller pairs 32-1 to 32-3, and in the second embodiment, the registration unit 50 includes four skewing roller pairs 32-1 to 32-4. However, the present technology is not limited thereto, and the number of skewing roller pairs may be any number.

In the first and second embodiments, the registration unit 50 includes four conveyance roller pairs 34-1 to 34-4. However, the present technology is not limited thereto, and the number of conveyance roller pairs may be any number. In the first and second embodiments, the conveyance roller pair 34-3 is slidable in the width direction. However, the present technology is not limited thereto, and another conveyance roller pair may be slidable. In particular, the conveyance roller pair 34-4 may be slidable in the width direction.

In the first and second embodiments, the position of the reference member 31 in the width direction is fixed, but the present technology is not limited thereto, and the reference member 31 may be moved in the width direction. For example, the reference member 31 may be moved in the width direction according to the detection result of the sheet position detection sensor 60 instead of adjusting the position of the sheet in the width direction by the conveyance roller pair 34-3. That is, it is conceivable that a relative distance between the sheet and the reference member 31 is made constant by moving the reference member 31 in the width direction, so that a distance by which the sheet is obliquely conveyed by the skewing roller pair is made constant.

In the first and second embodiments, a case where the registration unit 50 performs skew feeding correction at a position upstream of the secondary transfer portion 1C has been described. However, the present technology is not limited thereto, and for example, skew feeding correction may be performed at a position upstream of a processing unit for sheet cutting processing, binding processing, drilling processing, folding processing, or the like or an image reading unit.

In the present embodiment, the printer 1 has been described as an electrophotographic full-color laser beam printer, but the present technology is not limited thereto. For example, any configuration or method of the image forming unit that forms an image on a sheet, such as an inkjet printer, may be adopted.

The present disclosure can also be implemented by processing in which a program for implementing one or more functions of the embodiments is supplied to a system or a device via a network or a storage medium, and one or more processors in a computer of the system or the device read and execute the program. The present technology can also be implemented by a circuit (for example, an application-specific integrated circuit (ASIC)) that implements one or more functions.

According to the present disclosure, it is possible to reduce occurrence of a sliding mark caused by a rotary member pair in a non-nipping state.

### Other Embodiments

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-157502, filed Sep. 11, 2024 which is hereby incorporated by reference herein in its entirety.

What is claimed is:

1. A sheet conveyance apparatus comprising:
a conveyance rotary member pair configured to nip and convey a sheet;
an abutment portion disposed on one side in a width direction orthogonal to a sheet conveyance direction with respect to the sheet being conveyed;
a first skewing rotary member pair disposed downstream of the conveyance rotary member pair in the sheet conveyance direction and configured to obliquely convey the sheet toward the abutment portion;
a switching unit configured to switch the first skewing rotary member pair between a nipping conveyance state in which the sheet is nipped and conveyed and a non-nipping state in which nipping of the sheet is released;
a driving unit configured to rotationally drive the first skewing rotary member pair; and
a control unit configured to control the switching unit and the driving unit,
wherein the control unit is configured to
control a rotational speed of the first skewing rotary member pair to be a first speed in a case where the sheet is obliquely conveyed to the abutment portion by the first skewing rotary member pair, and
control the rotational speed of the first skewing rotary member pair to be a second speed lower than the first speed in a case where the first skewing rotary member pair is in the non-nipping state and the conveyance rotary member pair conveys the sheet.

2. The sheet conveyance apparatus according to claim 1, further comprising a downstream conveyance rotary member pair disposed downstream of the first skewing rotary member pair in the sheet conveyance direction and configured to nip and convey the sheet,
wherein the control unit is configured to control the rotational speed of the first skewing rotary member pair to be a third speed lower than the first speed in a case where the first skewing rotary member pair is in the non-nipping state and the downstream conveyance rotary member pair conveys the sheet.

3. The sheet conveyance apparatus according to claim 2, further comprising:
a first movement driving unit configured to move the downstream conveyance rotary member pair in the width direction; and
an arrival detection unit configured to detect arrival of the sheet at the downstream conveyance rotary member pair,
wherein in response to the arrival detection unit detecting the arrival of the sheet at the downstream conveyance rotary member pair, the control unit is configured to move the downstream conveyance rotary member pair by the first movement driving unit to move the sheet in the width direction such that a position of the sheet aligns with an image forming position in the width direction of an image to be formed on the sheet by an image forming unit, the image forming position being a position at which the image is formed on an image bearing member of the image forming unit.

4. The sheet conveyance apparatus according to claim 3, wherein upon the arrival detection unit detecting that the sheet has arrived at the downstream conveyance rotary member pair, the control unit is configured to switch the first skewing rotary member pair to the non-nipping state and move the downstream conveyance rotary member pair by the first movement driving unit.

5. The sheet conveyance apparatus according to claim 1,
wherein the switching unit is configured to switch the conveyance rotary member pair between a nipping conveyance state in which the sheet is nipped and conveyed and a non-nipping state in which nipping of the sheet is released, and
wherein the control unit is configured to switch the conveyance rotary member pair to the non-nipping state by the switching unit in a case where the sheet is obliquely conveyed to the abutment portion by the first skewing rotary member pair.

6. The sheet conveyance apparatus according to claim 1, further comprising:
a second movement driving unit configured to move the conveyance rotary member pair in the width direction; and
a width position detection unit configured to detect a position of an edge portion in the width direction of the sheet being nipped by the conveyance rotary member pair,
wherein the control unit is configured to
detect the position of the edge portion in the width direction of the sheet by the width position detection unit,
move the conveyance rotary member pair nipping the sheet by the second movement driving unit to move the sheet in the width direction such that the position of the edge portion is set to a set position that is separated from the abutment portion in the width direction, and
obliquely convey the sheet to the abutment portion by the first skewing rotary member pair in a case where the first skewing rotary member pair is in the nipping conveyance state after the sheet is moved in the width direction by the conveyance rotary member pair.

7. The sheet conveyance apparatus according to claim 1, further comprising a second skewing rotary member pair configured to obliquely convey the sheet toward the abutment portion,
wherein the second skewing rotary member pair is disposed such that the first skewing rotary member pair is positioned between the second skewing rotary member pair and the abutment portion in the width direction,
wherein the second skewing rotary member pair is disposed such that an angle between an oblique conveyance direction of the second skewing rotary member pair and the sheet conveyance direction is larger than an angle between an oblique conveyance direction of the first skewing rotary member pair and the sheet conveyance direction,
wherein the switching unit is configured to switch the second skewing rotary member pair between a nipping conveyance state in which the sheet is nipped and conveyed and a non-nipping state in which nipping of the sheet is released, and
wherein the control unit is configured to control the rotational speed of the first skewing rotary member pair to be a fourth speed higher than the first speed in a case where the first skewing rotary member pair is in the non-nipping state and the sheet is obliquely conveyed to the first skewing rotary member pair by the second skewing rotary member pair.

8. The sheet conveyance apparatus according to claim 1, further comprising a second skewing rotary member pair configured to obliquely convey the sheet toward the abutment portion,
wherein the second skewing rotary member pair is disposed such that the first skewing rotary member pair is positioned between the second skewing rotary member pair and the abutment portion in the width direction,
wherein the second skewing rotary member pair is disposed such that an angle between an oblique conveyance direction of the second skewing rotary member pair and the sheet conveyance direction is larger than an angle between an oblique conveyance direction of the first skewing rotary member pair and the sheet conveyance direction,
wherein the switching unit is configured to switch the second skewing rotary member pair between a nipping conveyance state in which the sheet is nipped and conveyed and a non-nipping state in which nipping of the sheet is released, and
wherein the control unit is configured to
control a rotational speed of the second skewing rotary member pair to be a fifth speed in a case where the first skewing rotary member pair is in the non-nipping state and the sheet is obliquely conveyed to the first skewing rotary member pair by the second skewing rotary member pair, and
control the rotational speed of the second skewing rotary member pair to be a sixth speed lower than the fifth speed in a case where the second skewing rotary member pair is in the non-nipping state and the sheet is obliquely conveyed to the abutment portion by the first skewing rotary member pair.

9. The sheet conveyance apparatus according to claim 5, further comprising a third driving unit configured to rotationally drive the conveyance rotary member pair,
wherein the control unit is configured to control such that a first ratio is different from a second ratio,
wherein the first ratio is a ratio between a rotational speed of the conveyance rotary member pair and the rotational speed of the first skewing rotary member pair in a case where a downstream end of the sheet conveyed by the conveyance rotary member pair in the sheet conveyance direction is at a position downstream of the first skewing rotary member pair and the first skewing rotary member pair is in the non-nipping state, and
wherein the second ratio is a ratio between the rotational speed of the conveyance rotary member pair and the rotational speed of the first skewing rotary member pair in a case where an upstream end of the sheet conveyed by the first skewing rotary member pair in the sheet conveyance direction is at a position upstream of the conveyance rotary member pair and the conveyance rotary member pair is in the non-nipping state.

10. A sheet conveyance apparatus comprising:
an abutment portion disposed on one side in a width direction orthogonal to a sheet conveyance direction with respect to a sheet being conveyed;
a first skewing rotary member pair configured to obliquely convey the sheet toward the abutment portion;
a second skewing rotary member pair configured to obliquely convey the sheet toward the abutment portion;
a first switching mechanism configured to switch the first skewing rotary member pair between a nipping conveyance state in which the sheet is nipped and conveyed and a non-nipping state in which nipping of the sheet is released;
a fourth switching mechanism configured to switch the second skewing rotary member pair between a nipping conveyance state in which the sheet is nipped and conveyed and a non-nipping state in which nipping of the sheet is released;
a first driving unit configured to rotationally drive the first skewing rotary member pair;
a fourth driving unit configured to rotationally drive the second skewing rotary member pair; and
a control unit configured to control the first switching mechanism, the fourth switching mechanism, the first driving unit, and the fourth driving unit,
wherein the second skewing rotary member pair is disposed such that the first skewing rotary member pair is positioned between the second skewing rotary member pair and the abutment portion in the width direction,
wherein the second skewing rotary member pair is disposed such that an angle between an oblique conveyance direction of the second skewing rotary member pair and the sheet conveyance direction is larger than an angle between an oblique conveyance direction of the first skewing rotary member pair and the sheet conveyance direction, and
wherein the control unit is configured to
control a rotational speed of the first skewing rotary member pair to be a first speed in a case where the second skewing rotary member pair is in the non-nipping state and the sheet is obliquely conveyed to the abutment portion by the first skewing rotary member pair, and
control the rotational speed of the first skewing rotary member pair to be a fourth speed higher than the first speed in a case where the first skewing rotary member pair is in the non-nipping state and the sheet is obliquely conveyed to the first skewing rotary member pair by the second skewing rotary member pair.

11. A sheet conveyance apparatus comprising:
an abutment portion disposed on one side in a width direction orthogonal to a sheet conveyance direction with respect to a sheet being conveyed;
a first skewing rotary member pair configured to obliquely convey the sheet toward the abutment portion;
a second skewing rotary member pair configured to obliquely convey the sheet toward the abutment portion;
a first switching mechanism configured to switch the first skewing rotary member pair between a nipping conveyance state in which the sheet is nipped and conveyed and a non-nipping state in which nipping of the sheet is released;
a fourth switching mechanism configured to switch the second skewing rotary member pair between a nipping conveyance state in which the sheet is nipped and conveyed and a non-nipping state in which nipping of the sheet is released;
a first driving unit configured to rotationally drive the first skewing rotary member pair;
a fourth driving unit configured to rotationally drive the second skewing rotary member pair; and
a control unit configured to control the first switching mechanism, the fourth switching mechanism, the first driving unit, and the fourth driving unit,
wherein the second skewing rotary member pair is disposed such that the first skewing rotary member pair is positioned between the second skewing rotary member pair and the abutment portion in the width direction,
wherein the second skewing rotary member pair is disposed such that an angle between an oblique conveyance direction of the second skewing rotary member pair and the sheet conveyance direction is larger than an angle between an oblique conveyance direction of the first skewing rotary member pair and the sheet conveyance direction, and
wherein the control unit is configured to
control a rotational speed of the second skewing rotary member pair to be a fifth speed in a case where the first skewing rotary member pair is in the non-nipping state and the sheet is obliquely conveyed to the first skewing rotary member pair by the second skewing rotary member pair, and
control the rotational speed of the second skewing rotary member pair to be a sixth speed lower than the fifth speed in a case where the second skewing rotary member pair is in the non-nipping state and the sheet is obliquely conveyed to the abutment portion by the first skewing rotary member pair.

12. An image forming apparatus comprising:
the sheet conveyance apparatus according to claim 1; and
an image forming unit disposed downstream of the sheet conveyance apparatus in the sheet conveyance direction and configured to form an image on the sheet.

13. The image forming apparatus according to claim 12, further comprising a re-conveyance unit configured to re-convey the sheet having a first side on which the image is formed by the image forming unit to the sheet conveyance apparatus.
